(19) United States
(12) Patent Application Publication
(10) Pub. No.: US 2015/0180020 A1
(43) Pub. Date: Jun. 25, 2015

(54) CARBONACEOUS MATERIAL FOR ANODE OF NANAQUEOUS ELECTROLYTE SECONDARY BATTERY, PROCESS FOR PRODUCING THE SAME, AND ANODE AND NONAQUEOUS ELECTROLYTE SECONDARY BATTERY OBTAINED USING THE CARBONACEOUS MATERIAL

(71) Applicants: Kureha Corporation, Tokyo (JP); Kureha Battery Materials Japan Co., Ltd., Tokyo (JP)

(72) Inventors: Mayu Komatsu, Tokyo (JP); Yasushi Ebihara, Tokyo (JP); Takashi Wakahoi, Tokyo (JP); Yasuhiro Tada, Tokyo (JP); Naohiro Sonobe, Tokyo (JP); Mao Suzuki, Tokyo (JP); Kayoko Okada, Tokyo (JP); Akitoshi Hatamochi, Tokyo (JP); Makoto Imaji, Tokyo (JP); Yasufumi Ikeyama, Tokyo (JP); Shota Kobayashi, Tokyo (JP); Kenta Aoki, Tokyo (JP)

(73) Assignee: Kureha Battery Materials Japan Co., Lt.d, Tokyo (JP)

(21) Appl. No.: 14/420,412

(22) PCT Filed: Aug. 30, 2013
(86) PCT No.: PCT/JP2013/073427

§ 371 Date: Feb. 9, 2015

(30) Foreign Application Priority Data
Sep. 6, 2012 (JP) 2012-196562
Sep. 6, 2012 (JP) 2012-196563
Sep. 6, 2012 (JP) 2012-196564
Sep. 6, 2012 (JP) 2012-196565
Sep. 6, 2012 (JP) 2012-196567
Sep. 6, 2012 (JP) 2012-196570

(51) Int. Cl. H01M 4/133; C01B 31/02; H01M 4/587

(52) U.S. Cl. CPC H01M 4/133; H01M 4/587; C01B 31/02; H01M 2004/027

(57) ABSTRACT

The object of the present invention is to provide a carbonaceous material for an anode of a nonaqueous electrolyte secondary battery which uses a plant-derived organic material as a raw material, has high purity so that alkali metals such as the potassium element are sufficiently removed by de-mineral, and has excellent cycle characteristics, and to provide a lithium ion secondary battery using the carbonaceous material.

The carbonaceous material for an anode of a nonaqueous electrolyte secondary battery is a carbonaceous material obtained by carbonizing a plant-derived organic material, the atom ratio of hydrogen atoms and carbon atoms (H/C) according to elemental analysis being at most 0.1, the average particle size Dᵥ₅₀ being from 2 to 50 μm, the average interlayer spacing of the 002 planes determined by X-ray diffraction being from 0.365 nm to 0.400 nm, the potassium element content being at most 0.5 mass %, the calcium element content being at most 0.02 mass %, and the true density determined by a pycnometer method using butanol being at least 1.44 g/cm³ and less than 1.54 g/cm³.

### TECHNICAL FIELD

The present invention relates to a carbonaceous material for anode of a nonaqueous electrolyte secondary battery subjected to oxidation and a production method thereof.

### BACKGROUND

In recent years, the notion of mounting large lithium ion secondary batteries, having high energy density and excellent output characteristics, in electric automobiles has been investigated in response to increasing concern over environmental issues. In small mobile device applications such as mobile telephones or notebook-size personal computers, the capacity per unit volume is important, so graphitic materials with a large density have primarily been used as anode active materials. However, lithium ion secondary batteries for automobiles are difficult to replace during use due to their large size and high cost. Therefore, durability is required to be the same level as that of an automobile, and there is a demand for the realization of a life span of at least 10 years (high durability). When graphitic materials or carbonaceous materials with a developed graphite structure are used, there is a tendency for damage to occur due to crystal expansion and contraction caused by repeated lithium doping and dedoping, which diminishes the charging and discharging repetition performance. Therefore, such materials are not suitable as anode materials for lithium ion secondary batteries for automobiles which require high cycle durability. In contrast, non-graphitizable carbon is suitable for use in automobile applications from the perspective of involving little particle expansion and contraction due to lithium doping and dedoping and having high cycle durability (Patent Document 1).

Conventionally, pitches, polymer compounds, plant-based organic materials, and the like have been studied as carbon sources for non-graphitizable carbon. There are petroleum-based pitches and coal-based pitches, and since they contain a large amount of metal impurities, it becomes necessary to remove the impurities at the time of use. One substance that falls under the category of a petroleum-based pitch is bottom oil refined from naphtha or the like in the process of producing ethylene. Bottom oil is a high-quality carbon source due to its small amounts of impurities, but there are large amounts of light components, and there is also the problem that the yield is low. These pitches have the property that they produce graphitizable carbon (such as coke) in response to heat treatment, and crosslinking treatment is essential to produce non-graphitizable carbon. In this way, many steps become necessary in order to prepare non-graphitizable carbon from pitches.

Non-graphitizable carbon can be obtained by heat-treating a polymer material, in particular a thermosetting resin such as a phenol resin or a furan resin. However, many steps are required to obtain non-graphitizable carbon beginning with the synthesis of a monomer, polymerization and carbonization. This increases the manufacturing cost and leads to many problems in a manufacturing method for an anode material for large batteries, which need to be process of manufacturing inexpensively in large quantities.

In contrast, the present inventors discovered that carbon sources from an organic material derived from plants are promising as anode materials since it can be doped with large amounts of active substances. Further, when a plant-derived organic material is used as a carbon source for a carbonaceous material for an anode, the mineral content such as the potassium element and the calcium element present in the organic material source cause an undesirable effect on the doping and dedoping characteristics of the carbonaceous material used as an anode, so a method of reducing the content of the potassium element by performing de-mineralization on a plant-derived organic material by means of acid washing (called liquid phase de-mineral hereafter) has been proposed (Patent Documents 2 and 3).

On the other hand, de-mineralization with warm water using waste coffee beans that have not been heat-treated at 300° C. or higher is disclosed in Patent Document 4. In this method using a raw material with no history of heat treatment at a high temperature, the potassium content can be reduced to at most 0.1 mass % even when using a raw material with a particle size of 1 mm or greater, and the filtering properties are also improved.

### CITATION LIST

### Patent Documents

Patent Document 1: Japanese Unexamined Patent Application Publication No. H08-064207A

Patent Document 2: Japanese Unexamined Patent Application Publication No. H09-161801A

Patent Document 3: Japanese Unexamined Patent Application Publication No. H10-21919A

Patent Document 4: Japanese Unexamined Patent Application Publication No. 2000-268823A

### SUMMARY OF INVENTION

### Technical Problem

There has been a demand for the industrialization of the aforementioned carbonaceous material containing a plant-derived organic material as a raw material due to the ease of acquiring the raw material. As a result of conducting extensive research on de-mineralization methods that can be used industrially in a production method for a plant-derived carbonaceous material for an anode, present inventors discovered that potassium and calcium can be removed by performing de-mineralization on a plant-derived organic material with an average particle size of at least 100 μm in an acidic solution with a pH level of 3.0 or lower prior to detarring.

However, in a carbonaceous material from a plant-derived organic material prepared by the technique described above, the order of the crystalline structure is high, and the average interlayer spacing of the d (002) planes contributing to lithium doping and dedoping is small. As a result, the true density of the carbonaceous material that is obtained becomes large. Therefore, there is a tendency for structural damage to occur due to the expansion and contraction of crystals caused by repeated lithium doping and dedoping, so the cycle characteristics are poor. Accordingly, when the operating temperature is high, the mobility of the lithium in the electrolyte also increases, so lithium doping and dedoping tends to occur even more easily, which accelerates structural damage and leads to the problem that the high-temperature cycle characteristics are dramatically diminished.

A first object of the present invention is to provide a carbonaceous material for an anode of a nonaqueous electrolyte secondary battery which uses a plant-derived organic material as a raw material, has high purity so that alkali metals such as the potassium element are sufficiently removed by de-mineralization, and has excellent cycle characteristics, and a lithium ion secondary battery using the carbonaceous material. A second object of the present invention is to provide a method for stably and efficiently producing a carbonaceous material for an anode of a nonaqueous electrolyte secondary battery having excellent high-temperature cycle characteristics.

### Solution to Problem

As a result of conducting extensive research for producing a carbonaceous material for an anode of a nonaqueous electrolyte secondary battery, from which alkali metals such as the potassium element have been sufficiently removed by de-mineralization and which has excellent high-temperature cycle characteristics, from a plant-derived organic material, the present inventors discovered that by performing an oxidation step of heating a plant-derived organic material at a temperature of from 200 to 400° C. in an oxidizing gas atmosphere after de-mineralization and prior to detarring, it is possible to restrict the true density to within a prescribed range, and as a result, it is possible to produce a lithium ion secondary battery having excellent high-temperature cycle characteristics. The present inventors thus completed the present invention.

Further, the present inventors discovered that in the oxidation described above, heat is generated due to an oxidation of the raw material, which causes the temperature inside the system to increase rapidly, so it is necessary to appropriately control the temperature inside the system. When it becomes difficult to suppress increases in the temperature inside the system due to oxidative heat generation, the gas generated by the thermolysis of the raw material and the oxidizing gas react, which may induce the combustion and thermal runaway of the raw material inside the system. Therefore, in order to suppress excessive increases in the temperature inside the system due to oxidative heat generation caused by drying or oxidation, it was previously necessary to appropriately control the temperature inside the system by supplying water into the system and cooling the inside of the system by means of the vaporization heat of water. A production method which expends an enormous amount of energy to dry a coffee extract residue containing a large amount of water, expends even more energy to heat the sample in the next step, and supplies water into the system in order to suppress heat generation at this time was inefficient from the perspective of production but was an unavoidable step.

As a result of conducting extensive research on methods for stably and efficiently producing a carbonaceous material for an anode of a nonaqueous electrolyte secondary battery having excellent high-temperature cycle characteristics, the present inventors discovered that when performing oxidation in an oxidizing gas atmosphere on a coffee extract residue (coffee bean-derived organic material) or a de-mineralized product thereof (de-mineralized coffee bean-derived organic material), by introducing and mixing a coffee extract residue (coffee bean-derived organic material) containing water or a de-mineralized product thereof (de-mineralized coffee bean-derived organic material) into the system to address excessive heat generation associated with the oxidation, it is possible to cool the material and control the temperature to a prescribed reaction temperature, and to produce a carbonaceous material having excellent high-temperature cycle characteristics. The present inventors thus completed the present invention.

Consequently, the present invention relates to:

[1] a carbonaceous material for an anode of a nonaqueous electrolyte secondary battery obtained by carbonizing a plant-derived organic material, an atom ratio of hydrogen atoms and carbon atoms (H/C) according to elemental analysis being at most 0.1, an average particle size Dᵥ₅₀ being at least 2 μm and at most 50 μm, an average interlayer spacing of the 002 planes determined by powder X-ray diffraction being at least 0.365 nm and at most 0.400 nm, a potassium element content being at most 0.5 mass %, a calcium element content being at most 0.02 mass %, and a true density determined by a pycnometer method using butanol being at least 1.44 g/cm³ and less than 1.54 g/cm³;

[2] the carbonaceous material for an anode of a nonaqueous electrolyte secondary battery according to [1], wherein the plant-derived organic material contains a coffee bean-derived organic material;

[3] the carbonaceous material for an anode of a nonaqueous electrolyte secondary battery according to [1] or [2], wherein the average particle size Dᵥ₅₀ is at least 2 μm and at most 8 μm;

[4] a manufacturing method for an intermediate for producing a carbonaceous material for an anode of a nonaqueous electrolyte secondary battery, the method comprising: a step of de-mineral a plant-derived organic material with an average particle size of at least 100 μm; an oxidation treatment step of heating the de-mineralized organic material at a temperature of at least 200° C. and at most 400° C. in an oxidizing gas atmosphere; and a step of detarring the oxidized organic material at a temperature of at least 300° C. and at most 1000° C.;

[5] the manufacturing method for an intermediate for producing a carbonaceous material for an anode of a nonaqueous electrolyte secondary battery according to [4], the method further comprising: a step of de-mineral a coffee bean-derived organic material with an average particle size of at least 100 μm; an oxidation step of heating and drying the de-mineralized coffee bean-derived organic material at a temperature of at least 200° C. and at most 400° C. in an oxidizing gas atmosphere while introducing and mixing the organic material; and a step of detarring the oxidized coffee bean-derived organic material at a temperature of at least 300° C. and at most 1000° C.;

[6] a manufacturing method for an intermediate for producing a carbonaceous material for an anode of a nonaqueous electrolyte secondary battery, the method comprising: an oxidation step of heating and drying a coffee bean-derived organic material with an average particle size of at least 100 μm at a temperature of at least 200° C. and at most 400° C. in an oxidizing gas atmosphere while introducing and mixing the organic material; a step of de-mineral the oxidized coffee bean-derived organic material; and a step of detarring the de-mineral coffee bean-derived organic material at a temperature of at least 300° C. and at most 1000° C.;

[7] the manufacturing method for an intermediate for manufacturing a carbonaceous material for an anode of a nonaqueous electrolyte secondary battery according to any one of [4] to [6], wherein de-mineral is performed using an acidic solution with a pH level of 3.0 or lower;

[8] the manufacturing method for an intermediate for manufacturing a carbonaceous material for a cathode of a nonaqueous electrolyte secondary battery according to any one of [4] to [7], wherein the de-mineral step is performed at a temperature of at least 0° C. and at most 80° C.;

[9] the manufacturing method according to any one of [4] to [8], further comprising a step of pulverizing the de-mineral organic material;

[10] an intermediate obtained by the method described in any one of [4] to [9];

[11] a manufacturing method for a carbonaceous material for a nonaqueous electrolyte secondary battery, the method comprising: a step of heat treatment the intermediate manufactured by the method described in any one of [4] to [8] at a temperature of at least 1000° C. and at most 1500° C.; and a step of pulverizing the intermediate or the heat treatment product thereof;

[12] a manufacturing method for a carbonaceous material for an anode of a nonaqueous electrolyte secondary battery, the method comprising a step of heat treatment the intermediate manufactured by the method described in [9] at a temperature of at least 1000° C. and at most 1500° C.;

[13] a carbonaceous material for an anode of a nonaqueous electrolyte secondary battery obtained by the manufacturing method described in [11] or [12];

[14] an anode for a nonaqueous electrolyte secondary battery containing the carbonaceous material for a cathode of a nonaqueous electrolyte secondary battery described in any one of [1] to [3] and [13];

[15] the anode for a nonaqueous electrolyte secondary battery according to [14] containing a water-soluble polymer;

[16] a nonaqueous electrolyte secondary battery comprising the anode for a nonaqueous electrolyte secondary battery described in [14] or [15];

[17] the nonaqueous electrolyte secondary battery according to [16] containing an additive having a LUMO value within a range of from at least −1.10 eV to at most 1.11 eV, the LUMO value being calculated using an AM1 (Austin Model 1) calculation method of a semiemperical molecular orbital method; and

[18] a vehicle in which the nonaqueous electrolyte secondary battery described in [16] or [17] is mounted.

Further, the present invention relates to:

[19] the carbonaceous material for an anode of a nonaqueous electrolyte secondary battery according to any one of [1] to [3], wherein the halogen content is at least 50 ppm and at most 10,000 ppm;

[20] the carbonaceous material for an anode of a nonaqueous electrolyte secondary battery according to [1] or [2], wherein the average particle size Dᵥ₅₀ is at least 2 μm and at most 50 μm;

[21] the carbonaceous material for an anode of a nonaqueous electrolyte secondary battery according to [3], wherein the average particle size Dᵥ₅₀ is at least 2 μm and at most 8 μm, and the proportion of particles of 1 μm or smaller is at most 10%;

[22] the manufacturing method for an intermediate for manufacturing a carbonaceous material for an anode of a nonaqueous electrolyte secondary battery according to any one of [4] to [9], wherein detarring is performed in an oxygen-containing atmosphere;

[23] an intermediate obtained by the method described in any one of [4] to [9] and [22];

[24] a manufacturing method for a carbonaceous material for a nonaqueous electrolyte secondary battery, the method comprising: a step of heat treatment the un-pulverized intermediate manufactured by the method described in [22] at a temperature of at least 1000° C. and at most 1500° C.; and a step of pulverizing the intermediate or the heat treatment product thereof;

[25] a manufacturing method for a carbonaceous material for an anode of a nonaqueous electrolyte secondary battery, the method comprising a step of heat treatment the un-pulverized intermediate manufactured by the method described in [22] at a temperature of at least 1000° C. and at most 1500° C.;

[26] the manufacturing method for a carbonaceous material for an anode of a nonaqueous electrolyte secondary battery according to any one of [11], [12], [24], and [25], wherein heat treatment is performed in an inert gas containing a halogen gas;

[27] a carbonaceous material for an anode of a nonaqueous electrolyte secondary battery obtained by the manufacturing method described in any one of [11], [12], [24], and [26];

[28] an anode for a nonaqueous electrolyte secondary battery containing the carbonaceous material for an anode of a nonaqueous electrolyte secondary battery described in any one of [1] to [3] and [27];

[29] the anode for a nonaqueous electrolyte secondary battery according to [28] containing a water-soluble polymer;

[30] the anode for a nonaqueous electrolyte secondary battery according to any one of [14], [15], [28], and [29] manufactured under a pressing force of from 2.0 to 5.0 tf/cm²;

[31] a nonaqueous electrolyte secondary battery comprising the anode for a nonaqueous electrolyte secondary battery described in any one of [14], [15], and [28] to [30];

[32] the nonaqueous electrolyte secondary battery according to [31] containing an additive having a LUMO value within a range of from at least −1.10 eV to at most 1.11 eV, the LUMO value being calculated using an AM1 (Austin Model 1) calculation method of a semiemperical molecular orbital method; and

[33] a vehicle in which the nonaqueous electrolyte secondary battery described in any one of [16], [17], [31], and [32] is mounted;

### Advantageous Effects of Invention

With the manufacturing method for a carbonaceous material for an anode of a nonaqueous electrolyte secondary battery according to the present invention, by performing oxidation prior to detarring, impurity ions, specifically the potassium element, are removed from the carbonaceous material, and the true density is simultaneously adjusted to within a specific range. Therefore, when the material is used as a battery, it is possible to improve the high-temperature cycle characteristics while maintaining the characteristics of non-graphitizable carbon. With the manufacturing method for a carbonaceous material for an anode of a nonaqueous electrolyte secondary battery according to the present invention, it is possible to industrially, and in large quantities, obtain a plant-derived carbonaceous material for an anode having excellent electrical characteristics as an anode. That is, the process can be smoothly and efficiently advanced by introducing and mixing a coffee extract residue (coffee bean-derived organic material) containing water or a de-mineralized product thereof (de-mineralized coffee bean-derived organic material) and then drying and oxidizing the product. The resulting carbonaceous material is uniform with minimal fluctuation in quality.

### BRIEF DESCRIPTION OF THE DRAWING

FIG. 1 illustrates the high-performance cycle characteristics of a nonaqueous electrolyte secondary battery using the carbonaceous material of the present invention as an anode.

### DESCRIPTION OF EMBODIMENTS

Embodiments of the present invention will be described hereinafter.

### [1] Carbonaceous Material for an Anode of a Nonaqueous Electrolyte Secondary Battery

The carbonaceous material for an anode of a nonaqueous electrolyte secondary battery according to the present invention (also simply called the carbonaceous material hereafter) is a carbonaceous material obtained by carbonizing a plant-derived organic material, the atom ratio of hydrogen atoms and carbon atoms (H/C) according to elemental analysis being at most 0.1, the average particle size Dᵥ₅₀ being from 2 to 50 μm, the average interlayer spacing of the 002 planes determined by X-ray diffraction being from 0.365 nm to 0.400 nm, the potassium element content being at most 0.5 mass %, the calcium element content being at most 0.02 mass %, and the true density determined by a pycnometer method using butanol being at least 1.44 g/cm³ and less than 1.54 g/cm³. In addition, the carbonaceous material for an anode of a nonaqueous electrolyte secondary battery according to the present invention preferably has an average particle size Dᵥ₅₀ from 2 to 8 μm.

The carbonaceous material of the present invention uses a plant-derived organic material as a raw material and is therefore a non-graphitizable carbonaceous material. Non-graphitizable carbon involves little particle expansion and contraction due to lithium doping and dedoping and has high cycle durability. Such a plant-derived organic material will be described in detail in the description of the manufacturing method of the present invention.

The H/C ratio of the carbonaceous material of the present invention is determined by measuring hydrogen atoms and carbon atoms by elemental analysis. Since the hydrogen content of the carbonaceous material decreases as the degree of carbonization increases, the H/C ratio tends to decrease. Accordingly, the H/C ratio is effective as an index expressing the degree of carbonization. The H/C ratio of the carbonaceous material of the present invention is not particularly limited but is at most 0.1 and more preferably at most 0.08. The H/C ratio is particularly preferably at most 0.05. When the ratio H/C of hydrogen atoms to carbon atoms exceeds 0.1, the amount of functional groups present in the carbonaceous material increases, and the irreversible capacity increases due to a reaction with lithium, which is not preferable.

The average particle size (volume average particle size: Dᵥ₅₀) of the carbonaceous material of the present invention is preferably from 2 to 50 μm. When the average particle size is less than 2 μm, the fine powder increase, so the specific surface area increases. The reactivity with an electrolyte solution increases, and the irreversible capacity, which is a capacity that is charged but not discharged, also increases, and the percentage of the cathode capacity that is wasted thus increases. Thus, this is not preferable. In addition, when manufacturing an anode, each cavity formed between the carbonaceous materials becomes small, and the movement of lithium in the electrolyte solution is suppressed, which is not preferable. The lower limit of the average particle size is preferably at least 2 μm, more preferably at least 3 μm, and particularly preferably at least 4 μm (specifically, at least 8 μm). On the other hand, when the average particle size is 50 μm or lower, free paths of lithium dispersion within particles are short, which enables rapid charging and discharging. Furthermore, in the case of a lithium ion secondary battery, increasing the electrode area is important for improving the input/output characteristics, so it is necessary to reduce the coating thickness of the active material on the current collector. In order to reduce the coating thickness, it is necessary to reduce the particle size of the active material. From this perspective, the upper limit of the average particle size is preferably at most 50 μm, further preferably at most 40 μm, more preferably at most 30 μm, particularly preferably at most 25 μm, and most preferably at most 20 μm.

In a specific aspect of the present invention, the average particle size (volume average particle size: Dᵥ₅₀) of the carbonaceous material may be from 1 to 8 μm but is preferably from 2 to 8 μm. When the average particle size is from 1 to 8 μm, the resistance of the electrode can be kept low, which makes it possible to reduce the irreversible capacity of the battery. In this case, the lower limit of the average particle size is preferably 1 μm and even more preferably 3 μm. In addition, when the average particle size is 8 μm or lower, free paths of lithium dispersion within particles are short, which enables rapid charging and discharging. Furthermore, in the case of a lithium ion secondary battery, increasing the electrode area is important for improving the input/output characteristics, so it is necessary to reduce the coating thickness of the active material on the current collector at the time of electrode preparation. In order to reduce the coating thickness, it is necessary to reduce the particle size of the active material. From this perspective, the upper limit of the average particle size is preferably at most 8 μm but is more preferably at most 7 μm. When the average particle size exceeds 8 μm, the surface area of the active material decreases, and the electrode reaction resistance increases, which is not preferable.

### (Fine Powder Removal)

The carbonaceous material of the present invention is preferably a material from which fine powder has been removed. When a carbonaceous material from which fine powder has been removed is used as an anode of a nonaqueous electrolyte secondary battery, the irreversible capacity decreases, and the charge-discharge efficiency improves. In the case of a carbonaceous material with a small amount of fine powder, the active material can be sufficiently adhered with a small amount of a binder. That is, the fine powder of a carbonaceous material containing a large amount of fine powder cannot be sufficiently adhered, so the long-term durability may be inferior.

The amount of fine powder contained in the carbonaceous material of the present invention is not particularly limited, but when the average particle size is from 2 to 50 μm (preferably a particle size of from 8 to 50 μm), the proportion of particles 1 μm or smaller is preferably at most 2 vol. %, more preferably at most 1 vol. %, and even more preferably at most 0.5 vol. %. When a carbonaceous material in which the proportion of particles 1 μm or smaller is greater than 2 vol. % is used, the irreversible capacity of the resulting battery becomes large, which may result in inferior cycle durability. In addition, when the particle size is from 1 to 8 μm (preferably a particle size of from 2 to 8 μm), although not particularly limited, the proportion of particles 1 μm or smaller is preferably at most 10 vol. %, more preferably at most 8 vol. %, and even more preferably at most 6 vol. %. When a carbonaceous material in which the proportion of particles 1 μm or smaller is greater than 10 vol. % is used, the irreversible capacity of the resulting battery becomes large, which may result in inferior cycle durability.

In carbonaceous materials with an average particle size of 10 μm, when comparing the irreversible capacity of secondary batteries produced using a carbonaceous material containing fine powder of 1 μm or smaller in an amount of 0.0 vol. % (containing practically no fine powder) and a carbonaceous material containing fine powder of 1 μm or smaller in an amount of 2.8 vol. %, the results are respectively 65 (mAh/g) and 88 (mAh/g), indicating that the irreversible capacity decreases when the amount of fine powder is smaller.

Accordingly, the present invention is a carbonaceous material for an anode of a nonaqueous electrolyte secondary battery obtained by carbonizing a plant-derived organic material, the atom ratio of hydrogen atoms and carbon atoms (H/C) according to elemental analysis being at most 0.1, the average particle size Dᵥ₅₀ being from 2 to 50 μm, the average interlayer spacing of the 002 planes determined by powder X-ray diffraction being from 0.365 nm to 0.400 nm, the potassium element content being at most 0.5 mass %, and the true density determined by a pycnometer method using butanol in which the proportion of particles of 1 μm or smaller is at most 10% being at least 1.44 g/cm³ and less than 1.54 g/cm³.

In addition, the present invention relates to a carbonaceous material for an anode of a nonaqueous electrolyte secondary battery obtained by carbonizing a plant-derived organic material, the atom ratio of hydrogen atoms and carbon atoms (H/C) according to elemental analysis being at most 0.1, the average particle size Dᵥ₅₀ being from 1 to 8 μm, the average interlayer spacing of the 002 planes determined by powder X-ray diffraction being from 0.365 nm to 0.400 nm, the potassium element content being at most 0.5 mass %, and the true density determined by a pycnometer method using butanol in which the proportion of particles of 1 μm or smaller is at most 2% being at least 1.44 g/cm³ and less than 1.54 g/cm³.

### (Elements in the Carbonaceous Material)

Plant-derived organic materials contain alkali metals (for example, potassium or sodium), alkali earth metals (for example, magnesium or calcium), transition metals (for example, iron or copper), and other elements, and it is also preferable to reduce the contents of these metals. When these metals are contained, impurities are eluted in the electrolyte at the time of dedoping from the anode, which is highly likely to have an adverse effect on the battery performance and/or safety.

The potassium element content in the carbonaceous material of the present invention is at most 0.5 mass %, more preferably at most 0.2 mass %, and even more preferably at most 0.1 mass %. In a nonaqueous electrolyte secondary battery using a carbonaceous material for an anode having a potassium content exceeding 0.5 mass %, the dedoping capacity may decrease, and the non-dedoping capacity may increase.

The content of calcium in the carbonaceous material of the present invention is at most 0.02 mass %, more preferably at most 0.01 mass %, and even more preferably at most 0.005 mass %. In a nonaqueous electrolyte secondary battery using a carbonaceous material for an anode having a large calcium content, minute short circuits may cause heat generation. In addition, this may also have an adverse effect on the doping characteristics and dedoping characteristics.

In addition, the halogen content contained in the carbonaceous material of the present invention, which is heat treated under a halogen gas-containing non-oxidizing gas atmosphere described below, is not particularly limited but is from 50 to 10,000 ppm, more preferably from 100 to 5000 ppm, and even more preferably from 200 to 3000 ppm.

Accordingly, the present invention is a carbonaceous material for an anode of a nonaqueous electrolyte secondary battery obtained by carbonizing a plant-derived organic material, the atom ratio of hydrogen atoms and carbon atoms (H/C) according to elemental analysis being at most 0.1, the average particle size Dᵥ₅₀ being from 2 to 50 μm, the average interlayer spacing of the 002 planes determined by powder X-ray diffraction being from 0.365 nm to 0.400 nm, the potassium element content being at most 0.5 mass %, the halogen content being from 50 to 10,000 ppm, and the true density determined by a pycnometer method using butanol being at least 1.44 g/cm³ and less than 1.54 g/cm³.

### (Average Interlayer Spacing of the Carbonaceous Material)

The average interlayer spacing of the (002) planes of a carbonaceous material indicates a value that decreases as the crystal integrity increases. The spacing of an ideal graphite structure yields a value of 0.3354 nm, and the value tends to increase as the structure is disordered. Accordingly, the average interlayer spacing is effective as an index indicating the carbon structure. The average interlayer spacing of the 002 planes determined by X-ray diffraction for the carbonaceous material for a nonaqueous electrolyte secondary battery according to the present invention is at least 0.365 nm, more preferably at least 0.370 nm, and even more preferably at least 0.375 nm. Similarly, the average interlayer spacing described above is at most 0.400 nm, more preferably at most 0.395 nm, and even more preferably at most 0.390 nm. When the interlayer spacing of the 002 planes is less than 0.365 nm, the doping capacity becomes small when used as an anode of a nonaqueous electrolyte secondary battery, or the expansion and contraction associated with the doping and dedoping of lithium becomes large, causing cavities to form between particles, and the conductive network between the particles is broken, which gives the product poor repeating characteristics and is particularly undesirable for automobile applications. In addition, when the interlayer spacing exceeds 0.400 nm, the non-dedoping capacity becomes large, which is not preferable.

### (True Density of the Carbonaceous Material)

The true density of the carbonaceous material of the present invention was determined by a pycnometer method using butanol. The true density of a graphitic material having an ideal structure is 2.2 g/cm³, and the true density tends to decrease as the crystal structure becomes disordered. Accordingly, the true density can be used as an index expressing the carbon structure. The true density of the carbonaceous material of the present invention is at least 1.44 g/cm³ and less than 1.54 g/cm³, and the lower limit is preferably at least 1.47 g/cm³ and even more preferably at least 1.50 g/cm³. The upper limit of the true density is preferably at most 1.53 g/cm³ and more preferably at most 1.52 g/cm³. When the true density is 1.54 g/cm³ or higher, the high-temperature cycle characteristics are diminished when used as a battery, and when the true density is less than 1.44 g/cm³, the electrode density decreases. This leads to decreases in the volume energy density of the battery, which is not preferable.

### (Specific Surface Area of the Carbonaceous Material)

The specific surface area (also called “SSA” hereafter) determined by a BET method of the nitrogen adsorption of the carbonaceous material of the present invention is not particularly limited but is preferably at most 13 m²/g, more preferably at most 12 m²/g, and even more preferably at most 10 m²/g. When a carbonaceous material having an SSA larger than 13 m²/g is used, the irreversible capacity of the resulting battery may become large. In addition, the lower limit of the specific surface area is preferably at least 1 m²/g, more preferably at least 1.5 m²/g, and even more preferably at least 2 m²/g. When a carbonaceous material having an SSA less than 1 m²/g is used, the discharge capacity of the battery may become small.

Although the mechanism by which the high-temperature cycle characteristics of the carbonaceous material for a nonaqueous electrolyte secondary battery according to the present invention improve has not been clarified in detail, the mechanism may be as follows. However, the present invention is not limited by the following explanation.

A plant-derived organic material is heated at a temperature of from 200 to 400° C. in an oxidizing gas atmosphere, and as a result, the terminal part of the cyclic structure of the plant-derived organic material is oxidized, and an oxygen-containing functional group to which oxygen atoms are added is generated. A cyclization reaction then progresses in the process of a heat treatment step, and an aromatic compound is produced. Simultaneously, a crosslinking structure is produced based on the oxygen-containing functional group. A carbonaceous material obtained from the oxidized plant-derived organic material then forms a state in which the crystals are disordered, and it is thought that the d (002) planes spacing becomes large as a result. When the d (002) plane spacing becomes large, the expansion and contraction of crystals due to lithium doping and dedoping are suppressed in a normal-temperature environment or a high-temperature environment, and it is thought that the cycle characteristics, the high-temperature cycle characteristics in particular, improve as a result. In addition, the order of the crystalline structure is relatively high in a carbonaceous material obtained from a coffee residue organic material among carbon structures classified as non-graphitizable carbon, and this carbonaceous material has the characteristic that the average interlayer spacing of the d (002) planes contributing to lithium doping and dedoping is small. Therefore, structural damage tends to occur due to the expansion and contraction of crystals caused by repeated lithium doping and dedoping, so the cycle characteristics are low, and the decrease in cycle characteristics accelerates dramatically at a high temperature of about 50° C. in comparison to room temperature. Accordingly, as a result of oxidation in which the coffee residue is heated in an oxidizing gas atmosphere, in particular, a crosslinking structure is produced based on the oxygen-containing functional group in the organic material derived from the coffee residue, and the crystals of the carbonaceous material obtained by this action form a more disordered state so that the d (002) plane spacing is kept large. As a result, the expansion and contraction of crystals due to lithium doping and dedoping in a normal-temperature environment or a high-temperature environment are suppressed, and it is thought that the cycle characteristics, the high-temperature cycle characteristics in particular, improve as a result.

### [2] Manufacturing Method for a Carbonaceous Material for an Anode of a Nonaqueous Electrolyte Secondary Battery

The manufacturing method for a carbonaceous material for an anode of a nonaqueous electrolyte secondary battery according to the present invention is a manufacturing method for a carbonaceous material which contains a plant-derived organic material with an average particle size of at least 100 μm as a raw material and comprises at least: (1) a step of de-mineral the material using an acidic solution (also called the “liquid phase de-mineral step” hereafter); (2) an oxidation step of heating the de-mineral organic material at a temperature of from 200 to 400° C. in an oxidizing gas atmosphere (also called the “oxidation step” hereafter); and (3) a step of detarring the oxidized organic material at a temperature of from 300 to 1000° C. (also called the “detarring step” hereafter). The manufacturing method for a carbonaceous material for an anode of a nonaqueous electrolyte secondary battery preferably includes (4) a step of pulverizing the de-mineralized organic material or carbonized product (detarred carbonized product or heat-treated carbonized product) to an average particle size of from 2 to 50 μm (also called the “pulverization step” hereafter); and/or (5) a step of heat treatment the material at a temperature of from 1000 to 1500° C. in a non-oxidizing atmosphere (also called the “heat treatment step” hereafter). Accordingly, the manufacturing method for a carbonaceous material for an anode of a nonaqueous electrolyte secondary battery according to the present invention comprises a liquid phase de-mineral step (1), an oxidation step (2), and a detarring step (3) and preferably includes a pulverization step (4) and/or a heat treatment step (5).

### (Plant-Derived Organic Material)

In plant-derived organic materials that can be used in the present invention, the plant serving as a raw material is not particularly limited, but examples include coffee beans, coconut shells, tea leaves, sugar cane, fruits (tangerines or bananas), straw, broadleaf trees, coniferous trees, bamboo, and rice husks. These plant-derived organic materials can be used alone or as a combination of two or more types. Of the plant-derived organic materials described above, an extract residue obtained by extracting the coffee drink component from coffee beans is particularly preferable in that some of the mineral content is removed when the coffee component is extracted, and of these, a coffee extract residue that is industrially extracted is moderately pulverized and can be obtained in large quantities.

Carbonaceous materials for anodes manufactured from these plant-derived organic materials (in particular, coffee bean extract residues) are useful as an anode material for a nonaqueous electrolyte secondary battery in that they enable the doping of large quantities of active materials. However, plant-derived organic materials contain large amounts of metal elements and, in particular, contain large amounts of potassium and calcium. In addition, a carbonaceous material manufactured from a plant-derived organic material containing large amounts of metal elements cause an undesirable effect on the electrochemical characteristics or safety when used as an anode. Accordingly, the content of the potassium element, calcium element, or the like contained in the carbonaceous material for an anode is preferably kept to a minimum.

The plant-derived organic material used in the present invention is preferably not heat-treated at a temperature of 500° C. or higher. When heat-treated at a temperature of 500° C. or higher, de-mineral may not be performed sufficiently due to the carbonization of the organic material. The plant-derived organic material used in the present invention is preferably not heat-treated. When heat-treated, the temperature is preferably at most 400° C., more preferably at most 300° C., even more preferably at most 200° C., and most preferably at most 100° C. However, when a coffee bean extract residue is used as a raw material, heat treatment at around 200° C. may be performed due to roasting, but the material can still be adequately used as the plant-derived organic material used in the present invention.

The plant-derived organic material used in the present invention preferably does not have advanced putrefaction. For example, when a coffee extract residue is used, microorganisms may grow as a result of long-term storage in a state containing a large amount of water, and organic materials such as lipids or proteins may be decomposed. In the carbonization process, part of these organic materials undergoes a cyclization reaction to form an aromatic compound with a carbon structure, and when the organic materials are decomposed due to putrefaction, the final carbon structure may differ.

When a coffee extract residue with advanced putrefaction is used, the true density of the resulting carbonaceous material may decrease. When the true density of the carbonaceous material decreases, the irreversible capacity may increase, which is not preferable. In addition, the water absorbability of the carbonaceous material increases, so the degree of deterioration due to atmospheric exposure becomes large.

### 1. De-Mineral Step

The de-mineral step in the manufacturing method of the present invention is basically a liquid phase de-mineral step in which the plant-derived organic material is treated in an acidic solution with a pH level of 3.0 or lower prior to detarring. This liquid phase de-mineral makes it possible to efficiently remove the potassium element, the calcium element, and the like and to more efficiently remove the calcium element than in cases in which an acid is not used, in particular. In addition, alkali metals, alkali earth metals, and transition metals such as copper or nickel can also be removed. In the liquid phase de-mineral step, the plant-derived organic material is preferably treated in an acidic solution with a pH level of 3.0 or lower at a temperature of at least 0° C. and at most 80° C. A secondary battery using a carbonaceous material obtained by liquid phase de-mineral at a temperature of at least 0° C. and at most 80° C. is particularly excellent with regard to discharge capacity and efficiency.

In the manufacturing methods of items [5] and [6] serving as specific embodiments of the present invention, the demineralization or de-mineral method may be either a liquid phase de-mineral method or a gaseous phase de-mineral method. De-mineral is possible from the raw material stage until any stage after the carbonaceous material is formed, but in order to minimize the potassium element content and the calcium element content, it is preferable to de-mineral the coffee extract residue serving as a raw material in the liquid phase prior to detarring. In the liquid phase de-mineral step, the coffee extract residue is treated in an aqueous phase prior to detarring so as to efficiently reduce the content of metal elements such as the potassium element. The conditions of the aqueous phase in the liquid phase de-mineral step are such that water may also be used, but the material is preferably treated in an acidic solution with a pH level of 3.0 or lower. Liquid phase de-mineral in an acidic solution with a pH level of 3.0 or lower makes it possible to efficiently remove the potassium element, the calcium element, and the like and to more efficiently remove the calcium element than in cases in which an acid is not used, in particular. In addition, alkali metals, alkali earth metals, and transition metals such as copper or nickel can also be efficiently removed.

The acid used in liquid phase de-mineral is not particularly limited, but examples include strong acids such as hydrochloric acid, hydrofluoric acid, sulfuric acid, and nitric acid, weak acids such as citric acid and acetic acid, or mixtures thereof, and hydrochloric acid or hydrofluoric acid is preferable.

The plant-derived organic material used in the present invention is preferably not heat-treated at a temperature of 500° C. or higher, but when the carbonization of the organic material progresses as a result of being heat-treated at a temperature of 500° C. or higher, sufficient de-mineral can be achieved by using hydrofluoric acid. For example, after a coffee extract residue was detarred at 700° C., liquid phase de-mineral was performed for 1 hour using 35% hydrochloric acid, and the material was then washed three times with water and dried. After being pulverized to 10 μm and subjected to final heat treatment at 1250° C., calcium remained at a concentration of 409 ppm, and potassium remained at a concentration of 507 ppm. On the other hand, when a mixed solution of 8.8% hydrochloric acid+11.5% hydrofluoric acid was used, potassium and calcium were under the detection limit (10 ppm or less) in fluorescent X-ray measurements.

The pH at the time of liquid phase de-mineral is not particularly limited as long as sufficient de-mineral is achieved, but the pH is preferably at most 3.0, more preferably at most 2.5, and even more preferably at most 2.0. When the pH exceeds 3.0, it may not be possible to sufficiently achieve de-mineral (in particular, it may not be possible to sufficiently remove the calcium element by de-mineral), which is problematic.

The treatment temperature in the liquid phase de-mineral of the present invention is not particularly limited, but de-mineral is performed at a temperature of at least 0° C. and at most 100° C., preferably at most 80° C., more preferably at most 40° C., and even more preferably at room temperature (0 to 40° C.). When the treatment temperature is at most 80° C., the true density of the carbonaceous material becomes high, and the discharge capacity or efficiency of the battery improves when used as a battery. In addition, when the de-mineral temperature is low, it takes a long time to perform sufficient de-mineral, whereas when the de-mineral temperature is high, treatment for a short amount of time is sufficient, but the true density of the carbonaceous material using butanol decreases, which is not preferable.

The liquid phase de-mineral time differs depending on the pH or treatment temperature and is not particularly limited, but the lower limit is preferably 1 minute, more preferably 3 minutes, even more preferably 5 minutes, even more preferably 10 minutes, and most preferably 30 minutes. The upper limit is preferably 300 minutes, more preferably 200 minutes, and even more preferably 150 minutes. When the time is short, de-mineral can be performed sufficiently, whereas when the time is long, there are problems from the perspective of operational efficiency.

The liquid phase de-mineral step (1) in the present invention is a step for removing potassium, calcium, and the like contained in the plant-derived organic material. The potassium content after the liquid phase de-mineral step (1) is preferably at most 0.5 mass %, more preferably at most 0.2 mass %, and even more preferably at most 0.1 mass %. In addition, the calcium content is preferably at most 0.02 mass %, more preferably at most 0.01 mass %, and even more preferably at most 0.005 mass %. This is because when the potassium content exceeds 0.5 mass % and the calcium content exceeds 0.02 mass %, not only does the dedoping capacity become small and the irreversible capacity become large in a nonaqueous electrolyte secondary battery using the resulting carbonaceous material for an anode, but these metal elements are eluted in the electrolyte, which causes short circuits at the time of reprecipitation and causes substantial safety problems.

The particle size of the plant-derived organic material used in liquid phase de-mineral is not particularly limited. However, when the particle size is too small, the permeability of the solution at the time of filtration after de-mineral decreases, so the lower limit of the particle size is preferably at least 100 μm, more preferably at least 300 μm, and even more preferably at least 500 μm. In addition, the upper limit of the particle size is preferably at most 10,000 μm, more preferably at most 8000 μm, and even more preferably at most 5000 μm.

Further, the plant-derived organic material is preferably pulverized to an appropriate average particle size (preferably from 100 to 50,000 μm, more preferably from 100 to 10,000 μm, and even more preferably from 100 to 5000 μm) prior to liquid phase de-mineral. This pulverization differs from the pulverization step (2) for pulverizing the material so that the average particle size after heat treatment is from 2 to 50 μm.

Although the mechanism by which potassium, other alkali metals, alkali earth metals, transition metals, and the like are efficiently removed by liquid phase de-mineral in the manufacturing method of the present invention is not clear, the mechanism is thought to be as follows. When the material undergoes heat treatment at a temperature of 500° C. or higher, carbonization progresses, and the material becomes hydrophobic, so the liquid acid does not penetrate to the inside of the organic material. In contrast, if the material has not undergone heat treatment, the material is hydrophilic, and the liquid acid penetrates to the inside of the organic material. As a result, it is thought that metals such as potassium contained in the plant-derived organic material are precipitated as chlorides or the like and removed by washing with water, but the present invention is not limited to the above explanation.

### 2. Oxidation Step

In the manufacturing method of the present invention, an oxidation step of heating the de-mineral organic material at a temperature of from 200 to 400° C. in an oxidizing gas atmosphere prior to detarring is essential. As a result of this oxidation, the order of the crystals of the carbonaceous material that is obtained is reduced, and the true density becomes moderately low, which makes it possible to reduce expansion and contraction at the time of lithium doping and dedoping and to improve the high-temperature cycle characteristics. In addition, oxidation may be further performed on the plant-derived organic material after liquid phase de-mineral and detarring.

By performing oxidation prior to detarring, the high-temperature cycle characteristics, in particular, can be improved by improving the yield of the carbonaceous material or reducing the order of the crystalline structure in comparison to cases in which the organic material is simply detarred. By performing oxidation, crosslinking mediated by the oxygen-containing functional groups of the organic material contained in the raw material progresses so as to form a polymer, and the proportion of the material not removed by detarring increases due to devolatilization. In addition, the oxygen crosslinking of the organic material due to oxidation reduces the order of the crystalline structure of carbon derived therefrom, and the expansion of the average interlayer spacing suppresses expansion or contraction due to lithium doping and dedoping.

The oxidation of the present invention is performed by heating the carbon source in an oxidizing gas atmosphere. Here, the oxidizing gas used in oxidation is not particularly limited but is preferably in a gaseous state containing elements such as oxygen, sulfur, or nitrogen, for example, and a gaseous atmosphere containing oxygen is preferable from the perspective of handleability. Air may also be used as the oxidizing gas. In addition, a mixed gas with nitrogen, helium, or argon, for example, may also be used. In the case of a mixed gas, although not particularly limited, a mixed gaseous atmosphere containing oxygen and nitrogen is preferable from the perspective of handleability.

The oxidation temperature is not particularly limited, and the optimal temperature differs depending on the oxidizing gas and the oxidation time. For example, in the case of a mixed gaseous atmosphere containing oxygen and nitrogen, the oxidation temperature is preferably from 200 to 400° C., more preferably from 220 to 360° C., and even more preferably from 240 to 320° C. When the temperature is less than 200° C., the oxidation of the plant-derived organic material becomes difficult, and the true density of crystals tends to not be reduced sufficiently. In the oxidation of the present invention, the reaction temperature is preferably controlled to a temperature of from 200 to 400° C. In addition, when the reaction temperature of oxidation is less than 200° C., drying and oxidation may not be sufficient, which is not preferable. On the other hand, when the temperature exceeds 400° C., oxidative decomposition tends to occur rather than the addition of oxygen due to oxidation since the treatment temperature is high, and the specific surface area of the resulting carbonaceous material increases, which is not preferable. Further, when the reaction temperature exceeds 400° C., it becomes difficult to reduce the temperature that increases due to heat generation, and the rate of oxidative decomposition of the carbon source increases, so the yield of the oxidation step decreases. The maximum reached temperature of the oxidation temperature is not particularly limited within the range of from 200 to 400° C. but is preferably at most 350° C. and more preferably at most 300° C. from the perspective of the yield of the oxidation step.

The oxidation time is not particularly limited, and the optimal time differs depending on the oxidation time and the oxidizing gas. For example, in the case of oxidation at a temperature of from 240 to 320° C. in a gaseous atmosphere containing oxygen, the oxidation time is preferably from 10 minutes to 3 hours, more preferably from 30 minutes to 2 hours 30 minutes, and even more preferably from 50 minutes to 1 hour 30 minutes.

When the particle size of the plant-derived organic material at the time of oxidation is small, an oxidative decomposition reaction tends to occur due to oxidation, which tends to increase the specific surface area of the resulting carbonaceous material. Therefore, the lower limit of the particle size is preferably at least 100 μm, more preferably at least 300 μm, and even more preferably at least 500 μm. On the other hand, when the particle size is too large, the addition of oxygen by means of oxidation tends to become difficult. Therefore, the upper limit of the particle size is preferably at most 10,000 μm, more preferably at most 8000 μm, and even more preferably at most 5000 μm.

In the manufacturing methods of items [5] and [6] serving as specific embodiments of the manufacturing method of the present invention, an oxidation step of heating a coffee extract residue (coffee bean-derived organic material) or a de-mineral coffee extract residue (de-mineral coffee bean-derived organic material) in an oxidizing gas atmosphere prior to detarring is essential. That is, the oxidation step (2) can be performed before or after the de-mineral step. The coffee extract residue or liquid phase de-mineral product thereof contains a large amount of water, and this must be dried in order to store or smoothly deliver the product to the next step. In the present invention, this drying process is performed together with oxidation, which makes it possible to achieve a reduction in steps and the conservation of energy. In addition, by adding and mixing a residue containing water into the reaction system with an excessive amount of heat generation due to the oxidation, the heat inside the reaction system is cooled, and the system is controlled to an appropriate temperature. Therefore, even when manufactured in a large amount, the oxidation conditions of the raw material can be made uniform, and the product of the carbonaceous material that is ultimately manufactured can be stabilized. The manufacturing method of the present invention does not exclude the further establishment of a separate drying step in addition to the oxidation step described above, and a drying step may be established as necessary in each step.

The water content of the coffee extract residue or the liquid phase de-mineral product thereof is not particularly limited but is preferably approximately 10 to 70%. When the water content is large, the treatment time required for oxidation and drying becomes long, and the range over which the amount to be introduced can be adjusted is small when the residue is added for the purpose of cooling. This makes it difficult to control the temperature and increases the amount of gas required and the amount of heat generated, which is not preferable.

Although not particularly limited, a vertical furnace or a horizontal furnace having a raw material supplying means and an oxidizing gas supplying means may be used for the oxidation of the present invention. The method for introducing the raw material powder may be a known method such as supplying a raw material powder that has been cut from a table feeder, for example, from a raw material supply tube. In addition, the gas flow rate or temperature may be set to a constant value among the steps, but it is preferable from the perspective of managing the step temperature to adjust and control the gas flow rate or the temperature inside the reaction system while monitoring the temperature or the like in the raw material powder.

The mixing method in the reaction system at the time of oxidation in the present invention is not particularly limited, but the materials may be mixed by an oxidation device equipped with a stirring device using a stirring blade, and a similar mechanical stirring device may also be used. In addition, the gas may be introduced from the bottom of a reaction device equipped with a perforated plate, and the raw material powder may be allowed to flow so as to achieve a form in which the inside of the reaction system is mixed.

When the temperature of the starting raw material exceeds 100° C., water vapor due to the evaporation of the water content adhered to and contained in the starting raw material produces a volatile gas of the fats and oils or the like contained in the starting raw material as the temperature of the starting raw material increases. When the temperature of the starting raw material increases and exceeds 300° C., a hydrocarbon gas (CₙHₘ) resulting from a thermolysis reaction of the components constituting the starting raw material or a mixed gas of hydrogen monoxide (CO) or carbon dioxide (CO₂) is produced, so a means for discharging and removing the gas should be provided.

### 3. Detarring Step

In the manufacturing method of the present invention, a carbonaceous precursor is formed by performing detarring on the carbon source. In addition, heat treatment for transforming the carbonaceous precursor into a carbonaceous material is called heat treatment. Heat treatment may be performed in a single stage or may be performed in two stages at low and high temperatures. In this case, heat treatment at a low temperature is called pre-heat treatment, and heat treatment at a high temperature is called final heat treatment. In this specification, cases in which it is not the main objective to form a carbonaceous precursor by removing volatile content or the like from the carbon source (detarring) or to transform the carbonaceous precursor into a carbonaceous material (heat treatment) are called “non-carbonization heat treatment” and are differentiated from “detarring” and “heat treatment”. Non-carbonization heat treatment refers to heat treatment at a temperature less than 500° C., for example. More specifically, the roasting or the like of coffee beans at around 200° C. is included in non-carbonization heat treatment. As described above, the plant-derived organic material used in the present invention is preferably not heat-treated at a temperature of 500° C. or higher, but the plant-derived organic material used in the present invention may be subjected to non-carbonization heat treatment.

Detarring is performed by heat treatment the carbon source at a temperature at least 300° C. and at most 1000° C. The temperature is more preferably at least 500° C. and less than 900° C. Detarring removes volatile matter such as CO₂, CO, CH₄, and H₂, for example, and the tar content so that the generation of these components can be reduced and the burden of the furnace can be reduced in final heat treatment. When the detarring temperature is less than 300° C., detarring becomes insufficient, and the amount of tar or gas generated in the final heat treatment step after pulverization becomes large. This may adhere to the particle surface and cause a decrease in battery performance without being able to maintain the surface properties after pulverization, which is not preferable. On the other hand, when the detarring temperature exceeds 1000° C., the temperature exceeds the tar-generating temperature range, and the used energy efficiency decreases, which is not preferable. Furthermore, the generated tar causes a secondary decomposition reaction, and the tar adheres to the intermediate and causes a decrease in performance, which is not preferable.

The detarring atmosphere is not particularly limited, but detarring is performed under an inert gas atmosphere, for example, and examples of inert gases include nitrogen or argon. In addition, detarring can be performed under reduced pressure at a pressure of 10 kPa or less, for example. The detarring time is also not particularly limited, but detarring may be performed for 0.5 to 10 hours, for example, and is more preferably performed for 1 to 5 hours. In addition, the pulverization step may also be performed after detarring.

In the manufacturing method of the present invention, a step for pulverizing the raw material, the intermediate, or the final treated product or a step for heat treatment the intermediate may be added as necessary in accordance with the intended purpose in addition to the steps described above.

When the intermediate after the detarring step (carbonaceous precursor) is pulverized, the average particle size Dᵥ₅₀ is preferably from 2 to 63 μm and more preferably from 1 to 10 μm. By setting the average particle size to this range, it is possible to ensure that the particle size of the carbonaceous material is within the range of the present invention after contraction in the subsequent heat treatment step (pre-heat treatment and final heat treatment). In addition, the content of potassium and calcium in the intermediate is preferably adjusted to at most 0.5 mass % and at most 0.02 mass %, respectively. Within these ranges, the concentration of each ion contained in the carbonaceous material after heat treatment can be set within the numerical ranges of the invention of this application.

### (Detarring Under an Oxygen-Containing Atmosphere)

In the present invention, detarring can also be performed under an oxygen-containing atmosphere. The oxygen-containing atmosphere is not particularly limited, and air, for example, can be used, but it is preferable for the oxygen content to be low. Accordingly, the oxygen content in the oxygen-containing atmosphere is preferably at most 20 vol. %, more preferably at most 15 vol. %, even more preferably at most 10 vol. %, and most preferably at most 5 vol. %. In addition, the oxygen content may also be at least 1 vol. %, for example.

Accordingly, the present invention relates to a manufacturing method for a carbonaceous material for a nonaqueous electrolyte secondary battery, preferably comprising: a liquid phase de-mineral step (1), an oxidation step (2), a detarring step (3), a pulverization step (4), and a heat treatment step (5), wherein the detarring step (3) is performed in an oxygen-containing atmosphere.

Ordinarily, when detarring is performed under an oxygen-containing atmosphere, this has adverse effects such as the occurrence of side reactions such as activation and an increase in the specific surface area of the carbonaceous material. Accordingly, it is ordinarily necessary to perform detarring under an inert gas (for example, nitrogen or argon) atmosphere. However, in the present invention, even when detarring is performed under an oxygen-containing atmosphere, an increase in specific surface area is not observed.

The occurrence of activation can be presumed from the specific surface area of the carbonaceous material after the heat treatment step (4) following detarring, and the specific surface area increases in a material in which activation has occurred. For example, when the detarring step (3) was performed under an oxygen-containing atmosphere using a plant-derived organic material (for example, coconut shell char) that had been heat-treated at 600° C., the specific surface area of the carbonaceous material after the heat treatment step (4) was 60 m²/g, but when the detarring step (3) was performed in an oxygen-containing atmosphere using a plant-derived organic material (for example, a coffee residue) that had not been heat treated at a temperature of 500° C. or higher, the specific surface area of the carbonaceous material after the heat treatment step (4) was 8 m²/g, and no increase in specific surface area was observed. This numerical value is equivalent to that of a carbonaceous material subjected to detarring in an inert gas atmosphere.

The reason that detarring is possible under an oxygen-containing atmosphere in the present invention is not clear, but the reason is thought to be as follows. The plant-derived organic material used in the present invention is not subjected to heat treatment at a high temperature, so large amounts of tar content or gas are generated in the detarring step. The tar content or gas that is generated is preferentially consumed by an oxidation, and it is presumed that activation does not occur because the oxygen reacting with the plant-derived organic material is exhausted.

In the present invention, detarring can be performed under an oxygen-containing atmosphere, so atmospheric control can be simplified. Further, by reducing the amount of inert gas such as nitrogen that is used, it is possible to reduce the manufacturing cost.

### 4. Pulverization Step

The pulverization step in the manufacturing method of the present invention is a step for pulverizing the organic material from which potassium and calcium have been removed (de-mineral organic material), the oxidized organic material, or the carbonized product (carbonized product after detarring or carbonized product after final heat treatment) to an average particle size of from 2 to 50 μm. That is, as a result of the pulverization step, the average particle size of the resulting carbonaceous material is adjusted to the range of from 2 to 50 μm. In the pulverization step, the material is preferably pulverized so that the average particle size after heat treatment is from 1 to 8 μm and more preferably from 2 to 8 μm. That is, as a result of the pulverization step, the average particle size of the resulting carbonaceous material is adjusted to the range from 1 to 8 μm and preferably from 2 to 8 μm. In this specification, a “carbonaceous material precursor” or an “intermediate” refers to a material after the completion of the detarring step. That is, the “carbonaceous precursor” and the “intermediate” in this specification are used with essentially the same meaning and include materials that have and have not been pulverized.

The pulverizer used for pulverization is not particularly limited, and a jet mill, a ball mill, a hammer mill, a rod mill, or the like, for example, or a combination thereof can be used, but a jet mill equipped with a classification function is preferable from the perspective that there is minimal fine powder generation. On the other hand, when a ball mill, a hammer mill, a rod mill, or the like is used, fine powder can be removed by performing classification after pulverization.

Examples of classification include classification with a sieve, wet classification, and dry classification. An example of a wet classifier is a classifier utilizing a principle such as gravitational classification, inertial classification, hydraulic classification, or centrifugal classification. In addition, an example of a dry classifier is a classifier utilizing a principle such as sedimentation classification, mechanical classification, or centrifugal classification.

In the pulverization step, pulverization and classification can be performed with a single apparatus. For example, pulverization and classification can be performed using a jet mill equipped with a dry classification function. Furthermore, an apparatus with an independent pulverizer and classifier can also be used. In this case, pulverization and classification can be performed continuously, but pulverization and classification may also be performed non-continuously.

The pulverized intermediate (carbonaceous precursor) may be heat treated by the heat treatment step. Depending on the heat treatment conditions, contraction of amount 0 to 20% may occur, so when the material is pulverized prior to heat treatment and the heat treatment step is then performed, the average particle size of the pulverized intermediate is preferably adjusted to a somewhat large size within the range of about 0 to 20% in order to ultimately obtain a carbonaceous material for an anode of a nonaqueous electrolyte secondary battery having an average particle size Dᵥ₅₀ of from 2 to 50 μm. The average particle size after pulverization is not particularly limited as long as the average particle size of the carbonaceous material that is ultimately obtained is from 2 to 50 μm, but specifically, the average particle size Dᵥ₅₀ is preferably adjusted to 2 to 63 μm, more preferably from 2 to 50 μm, even more preferably from 2 to 38 μm, yet even more preferably from 2 to 32 μm, and most preferably from 3 to 25 μm. After heat treatment, the average particle size of the pulverized carbonaceous precursor is preferably adjusted to a somewhat large size within the range of about 0 to 20% in order to obtain a carbonaceous material for an anode of a nonaqueous electrolyte secondary battery having an average particle size Dᵥ₅₀ of from 1 to 8 μm. The average particle size after pulverization is not particularly limited as long as the average particle size of the carbonaceous material that is ultimately obtained is from 2 to 8 μm, but specifically, the average particle size Dᵥ₅₀ is preferably adjusted to 1 to 10 μm and more preferably from 1 to 9 μm.

### (Fine Powder Removal)

The carbonaceous material of the present invention is preferably a material from which fine powder has been removed. By removing fine powder, it is possible to increase the long-term durability of the secondary battery. In addition, the irreversible capacity of the secondary battery can be reduced.

The method of removing fine powder is not particularly limited, and fine powder may be removed, for example, in the pulverization step using a pulverizer such as a jet mill equipped with a classification function. On the other hand, when a pulverizer not having a classification function is used, fine powder can be removed by performing classification after pulverization. Further, fine powder can be recovered using a cyclone or a bag filter after pulverization or after classification.

### 5. Heat Treatment Step

The heat treatment step in the manufacturing method of the present invention is a step of heat treatment the intermediate to form a carbonaceous material. For example, this step is performed at a temperature of from 1000° C. to 1500° C., and this is ordinarily called “final heat treatment” in the technical field of the present invention. In addition, in the heat treatment step of the present invention, pre-heat treatment may be performed as necessary prior to final heat treatment.

The heat treatment in the manufacturing method of the present invention can be performed in accordance with an ordinary procedure, and a carbonaceous material for an anode of a nonaqueous electrolyte secondary battery can be obtained by performing heat treatment. The intermediate may be pulverized prior to heat treatment. The heat treatment temperature is from 1000 to 1500° C. When the heat treatment temperature is less than 1000° C., a large amount of functional groups remain in the carbonaceous material, and the value of H/C increases. The irreversible capacity also increases due to a reaction with lithium, which is not preferable. The lower limit of the heat treatment temperature in the present invention is at least 1000° C., more preferably at least 1100° C., and particularly preferably at least 1150° C. On the other hand, when the heat treatment temperature exceeds 1500° C., the selective alignment of the carbon hexagonal plane increases, and the discharge capacity decreases, which is not preferable. The upper limit of the heat treatment temperature in the present invention is at most 1500° C., more preferably at most 1450° C., and particularly preferably at most 1400° C.

Heat treatment is preferably performed under a non-oxidizing gas atmosphere. Examples of non-oxidizing gases include helium, nitrogen, and argon, and these may be used alone or as a mixture. Further, final heat treatment may also be performed under a gas atmosphere in which a halogen gas such as chlorine is mixed with the non-oxidizing gas described above. The amount of gas supplied (circulated amount) is not particularly limited but is at least 1 mL/min, preferably at least 5 mL/min, and even more preferably at least 10 mL/min per 1 g of the de-mineral carbon precursor. In addition, heat treatment can also be performed under reduced pressure at a pressure of 10 kPa or less, for example. The heat treatment time is not particularly limited, but the retention time at a temperature of at least 1000° C., for example, may be from 0.05 to 10 hours, preferably from 0.05 to 3 hours, and more preferably from 0.05 to 1 hour. In addition, the pulverization step described above may also be performed after heat treatment.

### (Preliminary Heat Treatment)

In the manufacturing method of the present invention, pre-heat treatment may be performed. Pre-heat treatment is performed by heat treatment the carbon source at a temperature of at least 300° C. and less than 1000° C. and preferably at least 300° C. and less than 900° C. Pre-heat treatment removes volatile matter such as CO₂, CO, CH₄, and H₂, for example, and the tar content remaining even after the detarring step so that the generation of these components can be reduced and the burden of the furnace can be reduced in final heat treatment. That is, in addition to the detarring step, CO₂, CO, CH₄, H₂, or the tar content may also be removed by pre-heat treatment.

Pre-heat treatment is performed under an inert gas atmosphere, and examples of inert gases include nitrogen, argon, and the like. In addition, pre-heat treatment can be performed under reduced pressure at a pressure of 10 kPa or less, for example. The pre-heat treatment time is not particularly limited, but pre-heat treatment may be performed for 0.5 to 10 hours, for example, and is preferably performed for 1 to 5 hours. In addition, the pulverization step may also be performed after pre-heat treatment. Further, pre-heat treatment removes volatile matter such as CO₂, CO, CH₄, and H₂, for example, and the tar content remaining even after the detarring step so that the generation of these components can be reduced and the burden of the furnace can be reduced in final heat treatment.

(Heat Treatment with a Halogen Gas-Containing Non-Oxidizing Gas)

The heat treatment or pre-heat treatment in the present invention can be performed under a non-oxidizing gas containing a halogen gas atmosphere. Examples of the halogen gas that is used include chlorine gas, bromine gas, iodine gas, and fluorine gas, but chlorine gas is particularly preferable. Further, a substance which easily discharges a halogen at a high temperature such as CCl₄ or Cl₂F₂ may also be supplied using an inert gas as a carrier.

Heat treatment or pre-heat treatment with a halogen gas-containing non-oxidizing gas may be performed at the final heat treatment temperature (1000 to 1500° C.) but may also be performed at a lower temperature than that of final heat treatment (for example, 300° C. to 1000° C.). This temperature range is preferably from 800 to 1400° C. The lower limit of the temperature is preferably 800° C. and more preferably 850° C. The upper limit is preferably 1400° C., more preferably 1350° C., and most preferably 1300° C.

By heating the raw organic material and carbonizing the material via a step of heating the material under a halogen gas-containing atmosphere such as chlorine gas at the time of carbonization, the resulting carbonaceous material demonstrates an appropriate halogen content and has a fine structure suited to the doping of lithium. This makes it possible to achieve a large charge-discharge capacity. For example, in comparison to a case in which heat treatment was performed while supplying nitrogen gas at 0.2 L/min per 1 g of the carbon precursor, the discharge capacity increased by 7% when heat treatment was performed while supplying a mixed gas obtained by adding chlorine gas at 0.04 L/min to nitrogen gas at 0.2 L/min.

The halogen content contained in the carbonaceous material of the present invention, which is heat treated by a halogen gas-containing non-oxidizing gas atmosphere described below, is not particularly limited but is from 50 to 10,000 ppm, more preferably from 100 to 5000 ppm, and even more preferably from 200 to 3000 ppm.

The reason that a carbonaceous material for an anode of a nonaqueous electrolyte secondary battery having a large charge-discharge capacity is obtained by performing heat treatment or pre-heat treatment with a halogen gas-containing non-oxidizing gas is not certain, but it is thought that halogen reacts with the hydrogen atoms in the carbonaceous material and that carbonization progresses in a state in which hydrogen is rapidly removed from the carbonaceous material. In addition, halogen gas is also thought to have the effect of reducing residual mineral content as a result of reacting with the mineral content contained in the carbonaceous material. When the halogen content in the carbonaceous material is too small, hydrogen is not sufficiently removed in the course of the manufacturing process thereof, and there is a risk that the charge-discharge capacity will not sufficiently improve as a result. On the other hand, when the halogen content is too large, there may be the problem that the irreversible capacity increases as the residual halogen reacts with lithium inside the battery.

Accordingly, the present invention relates to a manufacturing method for a carbonaceous material for a nonaqueous electrolyte secondary battery, preferably comprising: a liquid phase de-mineral step (1), an oxidation step (2), a pulverization step (3), a detarring step (4), and a heat treatment step (5), wherein heat treatment is performed in an inert gas containing a halogen gas.

### <Intermediate Manufacturing Method>

The manufacturing method for the intermediate (carbonaceous precursor) of the present invention comprises a step of de-mineral a plant-derived organic material with an average particle size of at least 100 μm (de-mineral step), an oxidation step of heating the de-mineral organic material at a temperature of from 200 to 400° C. in an oxidizing gas atmosphere, and a step of detarring the oxidized organic material at a temperature of from 300 to 1000° C. (detarring step), and the method preferably also includes a step of pulverizing the de-mineral organic material (pulverization step). Further, the liquid phase de-mineral step described above is preferably performed at a temperature of at least 0° C. and at most 80° C.

The de-mineral step, the oxidation step, the detarring step, and the pulverization step are the same as the de-mineral step, the detarring step, the oxidation step, and the pulverization step in the manufacturing method for a carbonaceous material for an anode of a nonaqueous electrolyte secondary battery according to the present invention. In the manufacturing method for an intermediate according to the present invention, the pulverization step may be performed after the liquid phase de-mineral step or after the detarring step. In addition, the intermediate (carbonaceous precursor) obtained as a result of the detarring step may or may not be pulverized.

The manufacturing method of item [5] serving as a specific embodiment of the manufacturing method of the present invention comprises a step of de-mineral a coffee bean-derived organic material with an average particle size of at least 100 μm (de-mineral step), an oxidation step of heating and drying the de-mineral coffee bean-derived organic material at a temperature of from 200 to 400° C. in an oxidizing gas atmosphere while introducing and mixing the organic material, and a step of detarring the oxidized coffee bean-derived organic material at a temperature of from 300 to 1000° C. (detarring step).

Further, the manufacturing method of item [6] serving as a specific embodiment of the manufacturing method of the present invention comprises an oxidation step of heating and drying a coffee bean-derived organic material with an average particle size of at least 100 μm at a temperature of from 200 to 400° C. in an oxidizing gas atmosphere while introducing and mixing the organic material, a step of de-mineral the oxidized coffee bean-derived organic material (de-mineral step), and a step of detarring the de-mineral coffee bean-derived organic material at a temperature of from 300 to 1000° C. (detarring step).

The de-mineral step, the oxidation step, the detarring step, and the pulverization step are the same as the de-mineral step, the oxidation step, the detarring step, and the pulverization step in the manufacturing method for a carbonaceous material for an anode of a nonaqueous electrolyte secondary battery according to the present invention.

### [3] Anode of a Nonaqueous Electrolyte Secondary Battery

The anode of a nonaqueous electrolyte secondary battery according to the present invention contains the carbonaceous material for an anode of a nonaqueous electrolyte secondary battery according to the present invention.

### (Manufacturing of an Anode)

An anode using the carbonaceous material of the present invention can be manufactured by adding a binder to the carbonaceous material, adding and kneading an appropriate amount of an appropriate solvent to form an electrode mixture, applying the electrode mixture to a current collector made of a metal plate or the like, and then drying and pressure-forming the mixture. An electrode having high conductivity can be manufactured by using the carbonaceous material of the present invention without particularly adding a conductivity agent, but a conductivity agent may be added as necessary when preparing the electrode mixture for the purpose of imparting even higher conductivity. The conductivity agent that is used may be conductive carbon black, vapor grown carbon fiber (VGCF), a nanotube, or the like. The amount added differs depending on the type of the conductivity agent that is used, but when the added amount is too small, the expected conductivity cannot be achieved, which is not preferable. Conversely, when the added amount is too large, the dispersion of the conductivity agent in the electrode mixture becomes poor, which is not preferable. From this perspective, the proportion of the added amount of the conductivity agent is preferably from 0.5 to 10 mass % (here, it is assumed that the active material (carbonaceous material)+the amount of the binder+the amount of the conductivity agent=100 mass %), more preferably from 0.5 to 7 mass %, and particularly preferably from 0.5 to 5 mass %.

The binder is not particularly limited as long as it does not react with the electrolyte, PVDF (polyvinylidene fluoride), polytetrafluoroethylene, and a mixture of SBR (styrene-butadiene rubber) and CMC (carboxymethylcellulose) or the like. Of these, PVDF is preferable in that the PVDF adhering to the active material surface minimally inhibits lithium ion movement and in that favorable input/output characteristics can be achieved. A polar solvent such as N-methyl pyrrolidone (NMP) is preferably used to dissolve PVDF and form a slurry, but an aqueous emulsion such as SBR or CMC may also be dissolved in water.

When the added amount of the binder is too large, the resistance of the resulting electrode becomes large, so the internal resistance of the battery becomes large. This diminishes the battery characteristics, which is not preferable. In addition, when the added amount of the binder is too small, the bonds between the anode material particles and the current collector become insufficient, which is not preferable. The preferable amount of the binder that is added differs depending on the type of the binder that is used. In the case of a PVDF-type binder, the added amount is preferably from 3 to 13 mass % and more preferably from 3 to 10 mass %. On the other hand, in the case of a binder using water as a solvent, a plurality of binders such as a mixture of SBR and CMC are often used in combination, and the total amount of all of the binders that are used is preferably from 0.5 to 5 mass % and more preferably from 1 to 4 mass %. The electrode active material layer is typically formed on both sides of the current collector, but the layer may be formed on one side as necessary. The number of required current collectors or separators becomes smaller as the thickness of the electrode active material layer increases, which is preferable for increasing capacity. However, it is more advantageous from the perspective of improving the input/output characteristics for the electrode area of opposite electrodes to be wider, so when the active material layer is too thick, the input/output characteristics are diminished, which is not preferable. The thickness of the active material layer (on each side) is preferably from 10 to 80 μm, more preferably from 20 to 75 μm, and particularly preferably from 20 to 60 μm.

### (Water-Soluble Polymer Binder)

A water-soluble polymer may be used as the binder used in a preferable anode of a nonaqueous electrolyte secondary battery according to the present invention. By using a water-soluble polymer in the anode of a nonaqueous electrolyte secondary battery according to the present invention, it is possible to obtain a nonaqueous electrolyte secondary battery in which the irreversible capacity does not decrease due to exposure tests. In addition, a nonaqueous electrolyte secondary battery having excellent cycle characteristics can be obtained.

Such a water-soluble polymer can be used without any particular limitations as long as it is soluble in water. Specific examples include cellulose compounds, polyvinyl alcohol, starch, polyacrylamide, poly(meth)acrylic acid, ethylene-acrylic acid copolymers, ethylene-acrylamide-acrylic acid copolymers, polyethyleneimine, and derivatives or salts thereof. Of these, cellulose compounds, polyvinyl alcohol, poly(meth)acrylic acid, and derivatives thereof are preferable. In addition, it is even more preferable to use carboxymethylcellulose (CMC) derivatives, polyvinyl alcohol derivatives, and polyacrylic acid salts. These can be used alone or as a combination of two or more types.

The mass average molecular weight of the water-soluble polymer of the present invention is at least 10,000, more preferably at least 15,000, and even more preferably at least 20,000. When the mass average molecular weight is less than 10,000, the dispersion stability of the electrode mixture is diminished, and it tends to be eluted in the electrolyte, which is not preferable. In addition, the mass average molecular weight of the water-soluble polymer is at most 6,000,000 and more preferably at most 5,000,000. When the mass average molecular weight exceeds 6,000,000, the solubility in the solvent decreases, which is not preferable.

In the present invention, a water-insoluble polymer may be used in combination as a binder. These are dispersed in a water-based carrier to form an emulsion. Examples of preferable insoluble polymers include diene polymers, olefin polymers, styrene polymers (meth)acrylate polymers, amide polymers, imide polymers, ester polymers, and cellulose polymers.

Other thermoplastic resins used as binders for the anode can be used without any particular limitation as long as they have a binding effect and have resistance to the nonaqueous electrolyte that is used or resistance to electrochemical reactions with the anode. Specifically, two components including the water-soluble polymer and the emulsion described above are often used. The water-soluble polymer is primarily used as a dispersion-imparting agent or a viscosity adjusting agent, and the emulsion is critical for imparting the binding properties between particles and the flexibility of the electrode.

Of these, preferable examples include homopolymers or copolymers of conjugated diene monomers or acrylic acid ester monomers (including methacrylic acid ester-type monomers), and specific examples include polybutadiene, polyisoprene, polymethyl methacrylate, polymethyl acrylate, polyethyl acrylate, polybutyl acrylate, natural rubber, styrene-isoprene copolymers, 1,3-butadiene-isoprene-acrylonitrile copolymers, styrene-1,3-butadiene-isoprene copolymers, 1,3-butadiene-acrylonitrile copolymers, styrene-acrylonitrile-1,3-butadiene-methyl methacrylate copolymers, styrene-acrylonitrile-1,3-butadiene-itaconic acid copolymers, styrene-acrylonitrile-1,3-butadiene-methyl methacrylate-fumaric acid copolymers, styrene-1,3-butadiene-itaconic acid-methyl methacrylate-acrylonitrile copolymers, acrylonitrile-1,3-butadiene-methacrylic acid-methyl methacrylate copolymers, styrene-1,3-butadiene-itaconic acid-methyl methacrylate-acrylonitrile copolymers, styrene-acrylic acid n-butyl-itaconic acid-methyl methacrylate-acrylonitrile copolymers, styrene-acrylic acid n-butyl-itaconic acid-methyl methacrylate-acrylonitrile copolymers, acrylic acid 2-ethylhexyl-methyl acrylate-acrylic acid-methoxypolyethylene glycol monomethacrylate. Of these, polymers (rubbers) with rubber elasticity are suitably used. PVDF (polyvinylidene fluoride), PTFE (polytetrafluoroethylene), and SBR (styrene-butadiene rubber) are also preferable.

Further, examples of preferable water-insoluble polymers from the perspective of binding properties include carboxyl groups, carbonyloxy groups, hydroxyl groups, nitrile groups, carbonyl groups, sulfonyl groups, sulfoxyl groups, and epoxy groups. Particularly preferable examples of polar groups include carboxyl groups, carbonyloxy groups, and hydroxyl groups.

The content ratio of the water-soluble polymer in the binder described above is preferably from 8 to 100 mass %. When the ratio is less than 8 mass %, the water absorption resistance improves, but the cycle durability of the battery becomes insufficient.

When the added amount of the binder is too large, the resistance of the resulting electrode becomes large, so the internal resistance of the battery becomes large. This diminishes the battery characteristics, which is not preferable. In addition, when the added amount of the binder is too small, the bonds between the anode material particles and the current collector become insufficient, which is not preferable. The preferable added amount of the binder differs depending on the type of binder that is used, but in the case of a binder using water as a solvent, a plurality of binders such as a mixture of SBR and CMC are often used in combination, and the total amount of all of the binders that are used is preferably from 0.5 to 10 mass % and more preferably from 1 to 8 mass %.

Solvents that can be used are not particularly limited as long as it dissolves the binder described above and can favorably disperse the carbonaceous material. For example, one or two or more types selected from water, methyl alcohol, ethyl alcohol, propyl alcohol, N-methyl pyrrolidone (NMP), and the like can be used.

The electrode active material layer is typically formed on both sides of the current collector, but the layer may be formed on one side as necessary. The number of required current collectors or separators becomes smaller as the thickness of the electrode active material layer increases, which is preferable for increasing capacity. However, it is more advantageous from the perspective of improving the input/output characteristics for the electrode area of opposite electrodes to be wider, so when the active material layer is too thick, the input/output characteristics are diminished, which is not preferable. The thickness of the active material layer (on each side) is preferably from 10 to 80 μm, more preferably from 20 to 75 μm, and particularly preferably from 20 to 60 μm.

### (Press Force)

The press force in the manufacturing of an electrode using the carbonaceous material of the present invention is not particularly limited. However, the press force is preferably from 2.0 to 5.0 tf/cm², more preferably from 2.5 to 4.5 tf/cm², and even more preferably from 3.0 to 4.0 tf/cm². By applying a press force after the carbonaceous material is coated and dried, the contact between active materials improves, and the conductivity also improves. Therefore, it is possible to obtain an electrode with excellent long-term cycle durability. When the press force is too low, the contact between the active materials becomes insufficient, so the resistance of the electrode becomes high, and the coulombic efficiency decreases, which may diminish the long-term durability. In addition, when the press force is too high, the electrode may bend due to rolling, which may make winding difficult.

### [4] Nonaqueous Electrolyte Secondary Battery

The nonaqueous electrolyte secondary battery of the present invention contains the anode of a nonaqueous electrolyte secondary battery according to the present invention. The nonaqueous electrolyte secondary battery using an anode of a nonaqueous electrolyte secondary battery using a carbonaceous material according to the present invention demonstrates excellent output characteristics and excellent cycle characteristics.

### (Manufacturing of a Nonaqueous Electrolyte Secondary Battery)

When an anode for a nonaqueous electrolyte secondary battery is formed using the anode material of the present invention, the other materials constituting the battery such as the cathode material, separators, and the electrolyte solution are not particularly limited, and various materials that have been conventionally used or proposed for nonaqueous solvent secondary batteries can be used.

For example, laminated oxide-based (as represented by LiMO₂, where M is a metal such as LiCoO₂, LiNiO₂, LiMnO₂, or LiNiₓCo_{y}Mo_{z}O₂ (where x, y, and z represent composition ratios), for example), olivine-based (as represented by LiMPO₄, where M is a metal such as LiFePO₄, for example), and spinel-based (as represented by LiM₂O₄, where M is a metal such as LiMn₂O₄, for example) complex metal chalcogen compounds are preferable as cathode materials, and these chalcogen compounds may be mixed as necessary. A cathode is made by forming these cathode materials with an appropriate binder together with a carbonaceous material for imparting conductivity to the electrode and forming a layer on a conductive current collector.

A nonaqueous electrolyte solution used with this cathode and anode combination is typically formed by dissolving an electrolyte in a nonaqueous solvent. One type or two or more types of organic solvents such as propylene carbonate, ethylene carbonate, dimethyl carbonate, diethyl carbonate, dimethoxyethane, diethoxyethane, γ-butyl lactone, tetrahydrofuran, 2-methyl tetrahydrofuran, sulfolane, or 1,3-dioxolane, for example, may be used in combination as a nonaqueous solvent. In addition, LiClO₄, LiPF₆, LiBF₄, LiCF₃SO₃, LiAsF₆, LiCl, LiBr, LiB(C₆H₅)₄, LiN(SO₃CF₃)₂, or the like is used as an electrolyte. A secondary battery is typically formed by making a cathode layer and an anode layer formed as described above face one another via a liquid-permeable separator made of a nonwoven fabric or another porous material as necessary and immersing the product in an electrolyte solution. A permeable separator made of a nonwoven fabric or another porous material ordinarily used in secondary batteries can be used as a separator. Alternatively, a solid electrolyte formed from a polymer gel impregnated with an electrolyte solution may be used instead of or together with a separator.

### (Electrolyte Additive)

The nonaqueous electrolyte secondary battery of the present invention preferably contains an additive having a LUMO value within a range of from −1.10 to 1.11 eV in the electrolyte, wherein the LUMO value is calculated using an AM1 (Austin Model 1) calculation method of a semiemperical molecular orbital model. The nonaqueous electrolyte secondary battery using an anode of a nonaqueous electrolyte secondary battery using a carbonaceous material and an additive according to the present invention has high doping and dedoping capacity and demonstrates excellent high-temperature cycle characteristics.

The additive used in the nonaqueous electrolyte secondary battery of the present invention will be described hereinafter. A solid electrolyte interface (SEI) is typically formed by the reductive decomposition of an organic electrolyte at the time of the initial charge. Here, using an additive which reductively decomposes earlier than the electrolyte makes it possible to control the properties of the SEI and to improve the high-temperature cycle characteristics. In order to select such an additive, the LUMO (Lowest Unoccupied Molecular Orbital) theory can be applied. LUMO expresses a molecular orbital function with no electrons in the lowest energy level. When a molecule accepts electrons, the electrons are embedded in this energy level, but the degree of reduction is determined by the value thereof. A lower LUMO value indicates characteristics with higher reduction, and a higher LUMO value indicates reduction resistance.

The LUMO value of a compound added to the electrolyte is determined using the AM1 calculation method in the semiemperical molecular orbital method, which is a quantum chemical calculation method.

The semiemperical molecular orbital method is categorized by the assumptions and the types of parameters as AM1, PM3 (Parametric method 3), MNDO (Modified Neglect of Differential Overlap), CNDO (Complete Neglect of Differential Overlap), INDO (Intermediate Neglect of Differential Overlap), MINDO (Modified Intermediate Neglect of Differential Overlap), or the like. The AM1 calculation method was developed by Dewer et al. in 1985 by partially improving the MNDO method so as to be suitable for hydrogen bond calculations. The AM1 method in the present invention was proposed by the computer program package Gaussian 03 (Gaussian Co.), but the present invention is not limited to this method.

The operating procedure for calculating the LUMO method using Gaussian 03 will be described hereinafter. The visualization function included in the drawing program GaussView 3.0 was used for the modeling of the molecular structure at the stage prior to calculation. The molecular structure was created, and after the structure was optimized using the AM1 for the Hamiltonian in the “ground state” with a charge of “0”, a spin of “Singlet”, and a solvent effect of “none”, an energy-point calculation was performed at the same level. The structure having the smallest total electron energy value obtained by structural optimization was defined as the most stable structure, and the numerical value corresponding to the lowest unoccupied molecular orbit in the molecular structure was determined as the LUMO value. The results were converted to units of electron volts using 1 a.u.=27.2114 eV since the units are given in atomic units.

The LUMO value of the additive of the present invention determined by the AM1 method in the quantum chemical calculation method is preferably from −1.1 to 1.11 eV, more preferably from −0.6 to 1.0 eV, and even more preferably from 0 to 1.0 eV. When the LUMO value is 1.11 eV or higher, the material may not function as an additive, which is not preferable. In addition, when the LUMO value is −1.1 eV or lower, side reactions may be induced on the cathode side, which is not preferable.

Examples of additives with LUMO values from −1.10 to 1.11 eV include, but are not limited to, fluoroethylene carbonate (FEC, 0.9829 eV), trimethyl silyl phosphoric acid (TMSP, 0.415 eV), lithium tetrafluoroborate (LiBF4, 0.2376 eV), chloroethylene carbonate (ClEC, 0.1056 eV), propanesultone (PS, 0.0656 eV), ethylene sulfite (ES, 0.0248 eV), vinylene carbonate (VC, 0.0155 eV), vinyl ethylene carbonate (VEC, −0.5736 eV), dioxathiolane dioxide (DTD, −0.7831 eV), and lithium bis(oxalato)borate (LiBOB, −1.0427 eV).

When an anode for a nonaqueous electrolyte secondary battery is formed using the anode material of the present invention, with the exception of containing vinylene carbonate or fluoroethylene carbonate in the electrolyte, the other materials constituting the battery such as the cathode material, separators, and the electrolyte solution are not particularly limited, and various materials that have been conventionally used or proposed for nonaqueous solvent secondary batteries can be used.

An additive having a LUMO value within the range from −1.10 to 1.11 eV is contained in the electrolyte used in the nonaqueous electrolyte secondary battery, wherein the LUMO value is calculated using the AM1 calculation method in the semiemperical molecular orbital method, and one type or two or more types may be used in combination. The content in the electrolyte is preferably from 0.1 to 6 mass % and more preferably from 0.2 to 5 mass %. When the content is less than 0.1 mass %, a film originating from the reductive decomposition of the additive is not sufficiently formed, so the high-temperature cycle characteristics do not improve. When the content exceeds 6 mass %, a thick film is generated on the anode, so the resistance becomes large and the input/output characteristics are reduced.

A secondary battery is typically formed by making a cathode layer and an anode layer formed as described above face one another via a liquid-permeable separator made of a nonwoven fabric or another porous material as necessary and immersing the product in an electrolyte solution. A permeable separator made of a nonwoven fabric or another porous material ordinarily used in secondary batteries can be used as a separator. Alternatively, a solid electrolyte formed from a polymer gel impregnated with an electrolyte solution may be used instead of or together with a separator.

### [5] Vehicle

The lithium secondary battery of the present invention is suitable as a battery to be mounted in a vehicle such as an automobile, for example (typically as a lithium secondary battery for driving the vehicle).

The vehicle of the present invention is not particularly limited and may ordinarily be a vehicle known as an electric vehicle, or a hybrid vehicle with a fuel cell and an internal combustion engine, but the vehicle comprises at least a power supply device equipped with the battery described above, an electric driving mechanism for driving the vehicle by supplying power from the power supply device, and a control device for controlling the electric driving mechanism. Further, the vehicle may also be equipped with a rheostatic brake or a regenerative brake and a mechanism for charging the lithium secondary battery by converting energy generated by braking into electricity.

### Examples

The present invention will be described in detail hereinafter using working examples, but these working examples do not limit the scope of the present invention. The measurement methods for the physical properties of the carbonaceous material for a nonaqueous electrolyte secondary battery according to the present invention (“true density (β_{Bt}) determined by a pycnometer method using butanol (“butanol method” hereafter)”, “specific surface area (SSA) determined by nitrogen adsorption”, “atom ratio of hydrogen/carbon (H/C)”, “calculation of the average interlayer spacing (interlayer spacing of d (002) planes) determined by X-ray diffraction”, “average particle size (Dᵥ₅₀) determined by laser diffraction”, “true density determined by a dry density measurement method using helium (“helium method” hereafter)”, and “mineral content”) will be described hereafter, but the physical properties described in this specification, including those of the working examples, are based on values determined by the following methods.

### (True Density (ρ_{Bt}) Determined by a Butanol Method)

The true density was measured by a butanol method in accordance with the method prescribed in JIS R 7212. The mass (m₁) of a pycnometer with a bypass line having an internal volume of approximately 40 mL was precisely measured. Next, after a sample was placed flat at the base of the bottle so as to have a thickness of approximately 10 mm, the mass (m₂) was precisely measured. Next, 1-butanol was slowly added to the bottle to a depth of approximately 20 mm from the base. Next, the pycnometer was gently oscillated, and after it was confirmed that no large air bubbles were formed, the bottle was placed in a vacuum desiccator and gradually evacuated to a pressure of 2.0 to 2.7 kPa. The pressure was maintained for 20 minutes or longer, and after the generation of air bubbles stopped, the bottle was removed and further filled with 1-butanol. After a stopper was inserted, the bottle was immersed in a constant-temperature bath (adjusted to 30±0.03° C.) for at least 15 minutes, and the liquid surface of 1-butanol was aligned with the marked line. Next, the bottle was removed, and after the outside of the bottle was thoroughly wiped and the bottle was cooled to room temperature, the mass (m₄) was precisely measured.

Next, the same pycnometer was filled with only 1-butanol and immersed in a constant-temperature water bath in the same manner as described above. After the marked line was aligned, the mass (m₃) was measured. In addition, distilled water which was boiled immediately before use and from which the dissolved gas was removed was placed in the pycnometer and immersed in a constant-temperature water bath in the same manner as described above. After the marked line was aligned, the mass (m5) was measured. The value ρ_{Bt} was calculated using the following formula.

$${ρ}_{B} = \frac{{m}_{2} - {m}_{1}}{{m}_{2} - {m}_{1} - ( {m}_{4} - {m}_{3} )} \times \frac{{m}_{3} - {m}_{1}}{{m}_{5} - {m}_{1}} d \qquad [ Formula 1 ]$$

At this time, d is the specific gravity (0.9946) in water at 30° C. (0.9946).

### (True Density Determined by the Helium Method)

A dry automatic densimeter AccuPyc 1330 made by the Shimadzu Corporation was used to measure pH. Measurements were performed after the sample was dried for at least 5 hours at 200° C. in advance. 1 g of the sample was placed in a 10 cm³ cell, and measurements were performed at an ambient temperature of 23° C. The number of purge cycles was set to 5, and the average value of n=5 for which it was confirmed that the volume matched within 0.5% in repeated measurements was defined as pH.

The measurement device has a sample chamber and an expansion chamber, and the sample chamber has a pressure gauge for measuring the pressure inside the chamber. The sample chamber and the expansion chamber are connected by a connecting tube having a valve. A helium gas introduction tube having a stop valve is connected to the sample chamber, and a helium gas discharge tube having a stop valve is connected to the expansion chamber.

Specifically, measurements were taken as follows.

The volume of the sample chamber (V_{CELL}) and the volume of the expansion chamber (V_{EXP}) are measured in advance using calibration spheres of a known volume. A sample is placed in the sample chamber, and the inside of the system is filled with helium. The pressure inside the system at that time is defined as Pₐ. Next, the valves are closed, and helium gas is added to only the sample chamber until the pressure is increased to P₁. The valves are then opened, and when the expansion chamber and the sample chamber are connected, the pressure inside the system decreases to P₂ due to expansion.

The volume of the sample at this time (V_{SAMP}) is calculated using the following formula.

V_{SAMP}=V_{CELL}−[V_{EXP}/{(P₁−Pₐ)/(P₂−Pₐ)−1}] [Formula 2]

Accordingly, when the mass of the sample is defined as W_{SAMP}, the density is as follows:

ρ_{H}=W_{SAMP}/V_{SAMP} [Formula 3]

### (Specific Surface Area (SSA) Determined by Nitrogen Adsorption)

An approximation derived from the BET formula is shown below.

$${v}_{m} = \frac{1}{\{ v ( 1 - x ) \}} \qquad [ Formula 4 ]$$

A value vₘ was determined by a one-point method (relative pressure x=0.3) based on nitrogen adsorption at the temperature of liquid nitrogen using the approximation described above, and the specific area of the sample was calculated from the following formula.

$$SPECIFIC SURFACE AREA ( SSA ) = 4.35 \times {v}_{m} ( {m}^{2} \text{/} g ) \qquad [ Formula 5 ]$$

At this time, vₘ is the amount of adsorption (cm³/g) required to form a monomolecular layer on the sample surface; v is the amount of adsorption (cm³/g); and x is the relative pressure.

Specifically, the amount of adsorption of nitrogen in the carbonaceous material at the temperature of liquid nitrogen was measured as follows using a “Flow Sorb II2300” made by MICROMERITICS. A test tube was filled with the carbonaceous material pulverized to a particle size of approximately 5 to 50 μm, and the test tube was cooled to −196° C. while cooling the mixed gas consisting of helium:nitrogen=70:30 so as to adsorb nitrogen in the carbonaceous material. The test tube was then returned to room temperature. The amount of nitrogen desorbed from the sample at this time was measured with a thermal conductivity detector and used as the adsorption gas amount v.

### (Atom Ratio of Hydrogen/Carbon (H/C))

The atom ratio was measured in accordance with the method prescribed in JIS M8819. The atom ratio was determined as the ratio of the numbers hydrogen/carbon atoms from the mass ratio of hydrogen and carbon in a sample obtained by elemental analysis using a CHN analyzer.

### (Interlayer Spacing (Interlayer Spacing of d (002) Planes) Determined by X-Ray Diffraction)

A test holder is filled with a carbonaceous material powder, and an X-ray diffraction diagram is obtained using CuKα rays monochromatized with a Ni filter as a ray source. The peak position is determined by the centroid method (method of determining the centroid position of a diffraction line and determining the peak position at a corresponding value 2θ) and corrected using a diffraction peak of the (111) surface of high-purity silicone powder serving as a standard substance. The wavelength of the CuKα rays is set to 0.15418 nm, and d (002) is calculated from the Bragg's equation a shown below.

$$interlayer spacing of d ( 002 ) planes = \frac{λ}{2 \cdot sin θ} \\ ( {BRAGG}^{′} S EQUATION ) \qquad [ Formula 6 ]$$

λ: X-ray wavelength (CuKαm=0.15418 nm), θ: diffraction angle

### (Average Particle Size (Dᵥ₅₀) Determined by Laser Diffraction)

A dispersant (surfactant SN-WET 366 (made by the San Nopco Co.)) was added and blended into a sample. Next, after purified water was added and dispersed using ultrasonic waves, the particle size distribution within a particle size range of from 0.5 to 3000 μm was determined with a particle size distribution measurement device (“SALD-3000S” made by the Shimadzu Corporation) at a refractive index of from 2.0 to 0.1i. The average particle size Dᵥ₅₀ was determined from the resulting particle size distribution yielding a cumulative volume of 50%.

### (Mineral Content)

In order to measure the content ratios of potassium and calcium, a carbon sample containing each prescribed element of potassium and calcium was prepared in advance, and a calibration curve was created for the relationship between the potassium Kα ray intensity and the potassium content and for the relationship between the calcium Kα ray intensity and the calcium content using a fluorescent X-ray analyzer. Next, the potassium Kα ray and calcium Kα ray intensities in fluorescent X-ray analysis were measured, and the potassium content and the calcium content were determined from the calibration curve created above.

Fluorescent X-ray analysis was performed under the following conditions using a LAB CENTER XRF-1700 made by the Shimadzu Corporation. The measured area of the sample was determined from the area inside the circumference with a diameter of 20 mm using a top irradiation-type holder. The sample to be measured was mounted by placing 0.5 g of the sample in a polyethylene container with an inside diameter of 25 mm, and the back was pressed with a plankton net. The measurement surface was covered with a polypropylene film, and measurements were taken. The X-ray source was set to 40 kV and 60 mA. For potassium, LiF (200) was used as an analyzing crystal, while a gas flow-type proportional counting tube was used as a detector, and the range over which 2θ is from 90 to 140° was measured at a scanning speed of 8°/min. For calcium, LiF (200) was used as an analyzing crystal, while a scintillation counter was used as a detector, and the range over which 2θ is from 56 to 60° was measured at a scanning speed of 8°/min.

### Reference Example 1

First, 300 g of 1% hydrochloric acid was added to 100 g of an extracted coffee residue, and de-mineral was performed by repeating a washing operation of stirring for 1 hour at 100° C., filtering, and then washing with 300 g of water 3 times so as to obtain a de-mineral coffee extract residue. After the resulting de-mineral coffee extract residue was dried in a nitrogen gas atmosphere, preliminary carbonization was performed by means of detarring for 1 hour at 700° C. under a nitrogen air flow. This was pulverized using a rod mill to form carbon precursor microparticles. Next, this carbon precursor was subjected to final heat treatment for 1 hour at 1250° C. to obtain a reference carbonaceous material 1 with an average particle size of 10 μm.

### Reference Example 2

A reference carbonaceous material 2 was obtained in the same manner as in Reference Example 1 with the exception that the de-mineral step using an acid was not performed.

### Reference Example 3

After an extracted coffee residue was dried in a nitrogen gas atmosphere, the sample was detarred at 700° C. and subjected to preliminary carbonization. First, 300 g of 1% hydrochloric acid was added to 100 g of a coffee residue subjected to preliminary carbonization, and de-mineral was performed by repeating a washing operation of stirring for 1 hour at 100° C., filtering, and then washing with 300 g of water 3 times so as to obtain a de-mineral coffee extract residue. This was pulverized using a rod mill to form carbon precursor microparticles. Next, this carbon precursor was subjected to final heat treatment for 1 hour at 1250° C. to obtain a reference carbonaceous material 3 with an average particle size of 10 μm.

### Reference Example 4

After an extracted coffee residue was dried in a nitrogen gas atmosphere, the sample was detarred at 700° C. and subjected to preliminary carbonization. This was pulverized using a rod mill to form a finely powdered substance. First, 300 g of 1% hydrochloric acid was added to 100 g of a fine powder coffee residue subjected to preliminary carbonization, and de-mineral was performed by repeating a washing operation of stirring for 1 hour at 100° C., filtering, and then washing with 300 g of water 3 times so as to obtain a de-mineral coffee extract residue. Next, this carbon precursor was subjected to final heat treatment for 1 hour at 1250° C. to obtain a reference carbonaceous material 4 with an average particle size of 10 μm.

### Reference Example 5

A reference carbonaceous material 5 was obtained in the same manner as in Reference Example 1 with the exception that only water washing was repeated without using an acid at the time of de-mineral.

### (Active Material Doping-Dedoping Tests)

Anodes and nonaqueous electrolyte secondary batteries were produced by performing the following operations (a) to (c) using the reference carbonaceous materials 1 to 5 obtained in Reference Examples 1 to 5, and the electrode performances thereof were evaluated.

### (a) Electrode Production

First, NMP was added to 90 parts by mass of the carbonaceous material described above and 10 parts by mass of polyvinylidene fluoride (“KF#1100” made by the Kureha Corporation). This was formed into a pasty consistency and applied uniformly to copper foil. After this was dried, the sample was stamped out of the copper foil in a disc shape with a diameter of 15 mm, and this was pressed to form an electrode. The amount of the carbonaceous material in the electrode was adjusted to approximately 10 mg.

### (b) Production of a Test Battery

Although the carbonaceous material of the present invention is suitable for forming an anode for a nonaqueous electrolyte secondary battery, in order to precisely evaluate the discharge capacity (dedoping capacity) and the irreversible capacity (non-dedoping capacity) of the battery active material without being affected by fluctuation in the performances of the counter electrode, a lithium secondary battery was formed using the electrode obtained above together with a counter electrode comprising lithium metal with stable characteristics, and the characteristics thereof were evaluated.

The lithium electrode was prepared inside a glove box in an Ar atmosphere. An electrode (counter electrode) was formed by spot-welding a stainless steel mesh disc with a diameter of 16 mm on the outer lid of a 2016 type coin cell can in advance, stamping a thin sheet of metal lithium with a thickness of 0.8 mm into a disc shape with a diameter of 15 mm, and pressing the thin sheet of metal lithium into the stainless steel mesh disc.

Using a pair of electrodes produced in this way, LiPF₆ was added at a proportion of 1.5 mol/L to a mixed solvent prepared by mixing ethylene carbonate, dimethyl carbonate, and methyl ethyl carbonate at a volume ratio of 1:2:2 as an electrolyte solution. A polyethylene gasket was used as a fine porous membrane separator made of borosilicate glass fibers with a diameter of 19 mm to assemble a 2016 coin-type nonaqueous electrolyte lithium secondary battery in an Ar glove box.

### (c) Measurement of Battery Capacity

Charge-discharge tests were performed on a lithium secondary battery with the configuration described above using a charge-discharge tester (“TOSCAT” made by Toyo System Co., Ltd.). A lithium doping reaction for inserting lithium into the carbon electrode was performed with a constant-current/constant-voltage method, and a dedoping reaction was performed with a constant-current method. Here, in a battery using a lithium chalcogen compound for the cathode, the doping reaction for inserting lithium into the carbon electrode is called “charging”, and in a battery using lithium metal for a counter electrode, as in the test battery of the present invention, the doping reaction for the carbon electrode is called “discharging”. The manner in which the doping reactions for inserting lithium into the same carbon electrode thus differs depending on the pair of electrodes used. Therefore, the doping reaction for inserting lithium into the carbon electrode will be described as “charging” hereinafter for the sake of convenience. Conversely, “discharging” refers to a charging reaction in the test battery but is described as “discharging” for the sake of convenience since it is a dedoping reaction for removing lithium from the carbonaceous material. The charging method used here is a constant-current/constant-voltage method. Specifically, constant-current charging was performed at 0.5 mA/cm² until the terminal voltage reached 0 mV. After the terminal voltage reached 0 mV, constant-voltage charging was performed at a terminal voltage of 0 mV, and charging was continued until the current value reached 20 μA. At this time, a value determined by dividing the electricity supply by the mass of the carbonaceous material of the electrode is defined as the charge capacity per unit mass of the carbonaceous material (mAh/g). After the completion of charging, the battery circuit was opened for 30 minutes, and discharging was performed thereafter. Discharging was performed at a constant current of 0.5 mA/cm² until the final voltage reached 1.5 V. At this time, a value determined by dividing the amount of discharged electricity by the mass of the carbonaceous material of the electrode is defined as the discharge capacity per unit mass of the carbonaceous material (mAh/g). The irreversible capacity was calculated as the discharge capacity subtracted from the charge capacity. The charge-discharge capacity and irreversible capacity were determined by averaging 3 measurements for test batteries produced using the same sample. The battery characteristics are shown in Table 3.

The de-mineral and heat treatment conditions of the reference carbonaceous materials 1 to 5 prepared in Reference Examples 1 to 5, the contents of ions contained in the resulting carbonaceous materials, and the battery characteristics are respectively shown in Tables 1 to 3.

TABLE 1

| | De-mineral | | Acid | | De-mineral | De-mineral |
|---|---|---|---|---|---|---|
| | particle size | | concentration | | temperature | time |
| | [μm] | Acid type | [%] | pH | [° C.] | [min] |
| Reference | 1000< | Hydrochloric | 1 | 0.5 | 100 | 60 |
| Example 1 | | acid | | | | |
| Reference | — | — | — | — | — | — |
| Example 2 | | | | | | |
| Reference | 700 | Hydrochloric | 1 | 0.5 | 100 | 60 |
| Example 3 | | acid | | | | |
| Reference | 20 | Hydrochloric | 1 | 0.5 | 100 | 60 |
| Example 4 | | acid | | | | |
| Reference | 1000< | — | 0 | 7 | 100 | 60 |
| Example 5 | | | | | | |

TABLE 2

| | Calcium | Potassium | | | | | |
|---|---|---|---|---|---|---|---|
| | element | element | | | | | d₀₀₂ interlayer |
| | content | content | Dv₅₀ | | | ρ_{Bt} | spacing |
| | [ppm] | [ppm] | [μm] | SSA [m²/g] | H/C | [g/cm³] | [nm] |
| Reference | N.D. | N.D. | 10.2 | 6.2 | 0.01 | 1.59 | 0.377 |
| Example 1 | | | | | | | |
| Reference | 1930 | 1232 | 10.8 | 3.6 | 0.02 | 1.55 | 0.375 |
| Example 2 | | | | | | | |
| Reference | 913 | 1133 | 9.8 | 6.0 | 0.02 | 1.55 | 0.379 |
| Example 3 | | | | | | | |
| Reference | 40 | 412 | 10.0 | 5.4 | 0.02 | 1.55 | 0.379 |
| Example 4 | | | | | | | |
| Reference | 651 | 980 | 11.3 | 4.0 | 0.02 | 1.54 | 0.375 |
| Example 5 | | | | | | | |

TABLE 3

| | Charge | Discharge | Irreversible | |
|---|---|---|---|---|
| | capacity | capacity | capacity | Efficiency |
| | [mAh/g] | [mAh/g] | [mAh/g] | [%] |
| Reference | 533 | 455 | 78 | 85 |
| Example 1 | | | | |
| Reference | 449 | 387 | 62 | 86 |
| Example 2 | | | | |
| Reference | The potassium content and calcium content were high. | | | |
| Example 3 | | | | |
| Reference | The calcium content was high. | | | |
| Example 4 | | | | |
| Reference | 476 | 415 | 62 | 87 |
| Example 5 | | | | |

It can be seen from a comparison of reference carbonaceous material 1 and reference carbonaceous materials 2 to 5 obtained in the reference examples of the present invention that when liquid phase de-mineral is performed from reference carbonaceous materials 1 and 2, the potassium element and calcium element are dramatically reduced. In addition, it can also be seen that the charge capacity and discharge capacity both increase due to the decrease in the potassium element and the calcium element and that the pores originating from lithium doping and dedoping are increased.

It can be seen from a comparison of reference carbonaceous material 1 and reference carbonaceous materials 3 and 4 that when the plant-derived organic material is detarred prior to the liquid phase de-mineral step, the de-mineral efficiency for the potassium element and the calcium element decreases. In addition, it can be seen that even when these materials are pulverized and the de-mineral particle size is made to be small, the calcium element reduction efficiency is low when the organic material is detarred prior to the liquid phase de-mineral step. That is, it can be concluded that it is advantageous to perform liquid phase de-mineral before the order of the crystalline structure increases due to detarring.

It can be seen from a comparison of reference carbonaceous materials 1 and 5 that when de-mineral is performed by means of water washing alone using purified water without performing acid treatment with an acidic solution, the potassium element and the calcium element do not decrease. Therefore, it can be seen from the fact that there is residual mineral content that the charge capacity and the discharge capacity are low in the battery characteristics.

### Working Example 1

First, 171 g of 35% hydrochloric acid (special grade made by Junsei Chemical Co., Ltd.) and 5830 g of purified water were added to 2000 g of an extracted coffee residue (water content: 65%), and the pH was adjusted to 0.5. After the sample was stirred for 1 hour at a liquid temperature of 20° C., the sample was filtered to obtain an acid-treated coffee extract residue. Next, de-mineral was performed by repeating a water washing operation of adding 6000 g of purified water to the acid-treated coffee extract residue and stirring for 1 hour 3 times, and a de-mineral coffee extract residue was thus obtained.

After the resulting de-mineral coffee extract residue was dried at 150° C. in a nitrogen gas atmosphere, the sample was detarred for 1 hour at 380° C. in a tube furnace to obtain a detarred and de-mineral coffee extract residue. Next, 50 g of the resulting detarred and de-mineral coffee extract residue was placed in an alumina case, and oxidation was performed for 1 hour at 220° C. under an air flow in an electric furnace to obtain an oxidized coffee extract residue.

Next, 30 g of the oxidized coffee extract residue was subjected to preliminary carbonization by means of detarring for 1 hour at 700° C. under a nitrogen air flow in a tube furnace. This was pulverized with a rod mill to form carbonaceous precursor microparticles. Next, 10 g of the carbon precursor microparticles were placed in a horizontal tube furnace and then held and carbonized for 1 hour 1250° C. while flowing nitrogen gas so as to obtain carbonaceous material 1 with an average particle size of 10 μm.

### Working Example 2

Carbonaceous material 2 was obtained in the same manner as in Working Example 1 with the exception that the oxidation temperature in Working Example 1 was set to 260° C.

### Working Example 3

Carbonaceous material 3 was obtained in the same manner as in Working Example 1 with the exception that the oxidation temperature in Working Example 1 was set to 300° C.

### Working Example 4

Carbonaceous material 4 was obtained in the same manner as in Working Example 1 with the exception that the oxidation temperature in Working Example 1 was set to 350° C.

### Working Example 5

Carbonaceous material 5 was obtained in the same manner as in Working Example 1 with the exception that the oxidation temperature in Working Example 1 was set to 400° C.

### Comparative Example 1

First, 171 g of 35% hydrochloric acid (special grade, made by Junsei Chemical Co., Ltd.) and 5830 g of purified water were added to 2000 g of an extracted coffee residue (water content: 65%), and after the sample was stirred for 1 hour at a liquid temperature of 20° C., the sample was filtered to obtain an acid-treated coffee extract residue. Next, de-mineral was performed by repeating a water washing operation of adding 6000 g of purified water to the acid-treated coffee extract residue and stirring for 1 hour 3 times, and a de-mineral coffee extract residue was thus obtained.

Next, 50 g of the de-mineral coffee extract residue was subjected to preliminary carbonization by means of detarring for 1 hour at 700° C. under a nitrogen air flow in a tube furnace. This was pulverized with a rod mill to form carbonaceous precursor microparticles. Next, 10 g of the carbon precursor microparticles were placed in a horizontal tube furnace and then held and carbonized for 1 hour 1250° C. while flowing nitrogen gas so as to obtain comparative carbonaceous material 1 with an average particle size of 10 μm.

### Comparative Example 2

Comparative carbonaceous material 2 was obtained in the same manner as in Working Example 1 with the exception that the oxidation temperature in Working Example 1 was set to 190° C.

### Comparative Example 3

Comparative carbonaceous material 3 was obtained in the same manner as in Working Example 1 with the exception that the oxidation temperature in Working Example 1 was set to 410° C.

### (Active Material Doping-Dedoping Tests)

### (a) Electrode Production

First, NMP was added to 94 parts by mass of the carbonaceous material described above and 6 parts by mass of polyvinylidene fluoride (“KF#9100” made by the Kureha Corporation). This was formed into a pasty consistency and applied uniformly to copper foil. After this was dried, the sample was stamped out of the copper foil in a disc shape with a diameter of 15 mm, and this was pressed to form an electrode. The amount of the carbonaceous material in the electrode was adjusted to approximately 10 mg.

### (b) Production of a Test Battery

Although the carbonaceous material of the present invention is suitable for forming an anode for a nonaqueous electrolyte secondary battery, in order to precisely evaluate the discharge capacity (dedoping capacity) and the irreversible capacity (non-dedoping capacity) of the battery active material without being affected by fluctuation in the performances of the counter electrode, a lithium secondary battery was formed using the electrode obtained above together with a counter electrode comprising lithium metal with stable characteristics, and the characteristics thereof were evaluated.

The lithium electrode was prepared inside a glove box in an Ar atmosphere. An electrode (counter electrode) was formed by spot-welding a stainless steel mesh disc with a diameter of 16 mm on the outer lid of a 2016 type coin cell can in advance, stamping a thin sheet of metal lithium with a thickness of 0.8 mm into a disc shape with a diameter of 15 mm, and pressing the thin sheet of metal lithium into the stainless steel mesh disc.

Using a pair of electrodes produced in this way, LiPF₆ was added at a proportion of 1.5 mol/L to a mixed solvent prepared by mixing ethylene carbonate, dimethyl carbonate, and methyl ethyl carbonate at a volume ratio of 1:2:2 as an electrolyte solution. A polyethylene gasket was used as a fine porous membrane separator made of borosilicate glass fibers with a diameter of 19 mm to assemble a 2016 coin-type nonaqueous electrolyte lithium secondary battery in an Ar glove box.

### (c) Measurement of Battery Capacity

Charge-discharge tests were performed on a lithium secondary battery with the configuration described above using a charge-discharge tester (“TOSCAT” made by Toyo System Co., Ltd.). A lithium doping reaction for inserting lithium into the carbon electrode was performed with a constant-current/constant-voltage method, and a dedoping reaction was performed with a constant-current method. Here, in a battery using a lithium chalcogen compound for the cathode, the doping reaction for inserting lithium into the carbon electrode is called “charging”, and in a battery using lithium metal for a counter electrode, as in the test battery of the present invention, the doping reaction for the carbon electrode is called “discharging”. The manner in which the doping reactions for inserting lithium into the same carbon electrode thus differs depending on the pair of electrodes used. Therefore, the doping reaction for inserting lithium into the carbon electrode will be described as “charging” hereinafter for the sake of convenience. Conversely, “discharging” refers to a charging reaction in the test battery but is described as “discharging” for the sake of convenience since it is a dedoping reaction for removing lithium from the carbonaceous material. The charging method used here is a constant-current/constant-voltage method. Specifically, constant-current charging was performed at 0.5 mA/cm² until the terminal voltage reached 0 mV. After the terminal voltage reached 0 mV, constant-voltage charging was performed at a terminal voltage of 0 mV, and charging was continued until the current value reached 20 μA. At this time, a value determined by dividing the electricity supply by the mass of the carbonaceous material of the electrode is defined as the charge capacity per unit mass of the carbonaceous material (mAh/g). After the completion of charging, the battery circuit was opened for 30 minutes, and discharging was performed thereafter. Discharging was performed at a constant current of 0.5 mA/cm² until the final voltage reached 1.5 V. At this time, a value determined by dividing the amount of discharged electricity by the mass of the carbonaceous material of the electrode is defined as the discharge capacity per unit mass of the carbonaceous material (mAh/g). The irreversible capacity was calculated as the discharge capacity subtracted from the charge capacity. The charge-discharge capacity and irreversible capacity were determined by averaging 3 measurements for test batteries produced using the same sample.

### (High-Temperature Cycle Test)

The discharge capacity after 150 cycles at 50° C. in a battery combined with an LiCoO₂ cathode was determined as the % capacity retention with respect to the initial discharge capacity. The details thereof are as follows.

LiCoO₂ (“Cell Shield C5-H” made by Nippon Chemical Industrial Co., Ltd.) was used as a cathode material (active material), and 94 parts by mass of this cathode material, 3 parts by mass of acetylene black, and 3 parts by mass of a polyvinylidene fluoride binder (“KF#1300” made by Kureha Corporation) were mixed. Next, N-methyl-2-pyrrolidone (NMP) was added and formed into a pasty consistency, and this was applied uniformly to one side of a strip-shaped piece of aluminum foil with a thickness of 20 μm. After this was dried, the resulting sheet-like electrode was stamped into a disc shape with a diameter of 14 mm, and this was pressed to form a cathode.

An anode (carbon electrode) was formed into a pasty consistency by adding NMP to 94 parts by mass of each of the anode materials produced in the working examples or comparative examples described above and to 6 parts by mass of polyvinylidene fluoride (“KF#9100” made by Kureha Corporation) and applied uniformly to copper foil. After this was dried, the resulting sheet-like electrode was stamped into a disc shape with a diameter of 15 mm, and this was pressed to form an anode. The amount of the anode material (carbonaceous material) in the electrode was adjusted to approximately 10 mg.

Using cathodes and anodes prepared in this way, LiPF₆ was added at a proportion of 1.5 mol/L to a mixed solvent prepared by mixing ethylene carbonate, dimethyl carbonate, and methyl ethyl carbonate at a volume ratio of 1:2:2 as an electrolyte solution. A polyethylene gasket was used as a fine porous membrane separator made of borosilicate glass fibers with a diameter of 19 mm to assemble a 2032 coin-type nonaqueous electrolyte lithium secondary battery in an Ar glove box. Charge-discharge tests were performed on lithium ion secondary batteries with such a structure.

Charging was performed with a constant current/constant voltage method. The charging conditions were set to a charging upper limit voltage of 4.2 V and a charging current of 2 C (that is, the current required to charge in 30 minutes). After a voltage of 4.2 V was reached, the current was attenuated while the voltage was kept constant, and charging was considered to end at the point when the current reached 1/100 C. Next, discharging was performed by applying a current in the opposite direction. Discharging was performed at a current of 2 C, and discharging was considered to end at the point when the voltage reached 2.75 V. This charging and discharging were repeatedly performed in a constant-temperature bath at 50° C., and the high-temperature cycle characteristics were evaluated.

In the evaluation of the high-temperature cycle characteristics, a value determined by dividing the discharge capacity after 150 cycles by the discharge capacity of the first cycle was used as the discharge capacity retention rate (%).

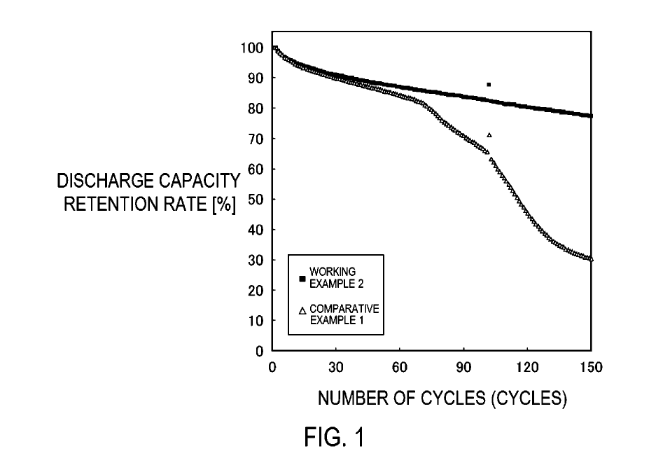

The physical properties of carbonaceous materials 1 to 5 and comparative carbonaceous materials 1 to 3 are shown in Table 4, and the performances of lithium ion secondary batteries produced using these carbonaceous materials are shown in Table 5. In addition, the changes in the charge capacity retention rate with respect to the number of charge-discharge cycles of the carbonaceous material 2 and comparative carbonaceous material 1 are shown in FIG. 1.

TABLE 4

| | Oxidation | heat treatment | K element | Ca element |
|---|---|---|---|---|
| | temperature | temperature | content | content |
| | [° C.] | [° C.] | [%] | [%] |
| Working | 220 | 1250 | N.D. | N.D. |
| Example 1 | | | | |
| Working | 260 | 1250 | N.D. | N.D. |
| Example 2 | | | | |
| Working | 300 | 1250 | N.D. | N.D. |
| Example 3 | | | | |
| Working | 350 | 1250 | N.D. | N.D. |
| Example 4 | | | | |
| Working | 400 | 1250 | N.D. | N.D. |
| Example 5 | | | | |
| Comparative | None | 1250 | N.D. | N.D. |
| Example 1 | | | | |
| Comparative | 190 | 1250 | N.D. | M.D. |
| Example 2 | | | | |
| Comparative | 410 | 1250 | N.D. | M.D. |
| Example 3 | | | | |

| | | | | d₀₀₂ planes | |
|---|---|---|---|---|---|
| | Dv₅₀ | | SSA | spacing | ρ_{Bt} |
| | [μm] | H/C | [m²/g] | [nm] | [g/cm³] |
| Working | 9.2 | 0.01 | 4.2 | 0.380 | 1.51 |
| Example 1 | | | | | |
| Working | 8.6 | 0.01 | 7.2 | 0.382 | 1.48 |
| Example 2 | | | | | |
| Working | 9.8 | 0.01 | 7.5 | 0.385 | 1.48 |
| Example 3 | | | | | |
| Working | 9.8 | 0.01 | 8.0 | 0.385 | 1.46 |
| Example 4 | | | | | |
| Working | 9.0 | 0.01 | 8.4 | 0.385 | 1.44 |
| Example 5 | | | | | |
| Comparative | 11.1 | 0.01 | 5.0 | 0.378 | 1.56 |
| Example 1 | | | | | |
| Comparative | 10.0 | 0.01 | 5.0 | 0.378 | 1.54 |
| Example 2 | | | | | |
| Comparative | 10.0 | 0.01 | 12.0 | 0.385 | 1.43 |
| Example 3 | | | | | |

TABLE 5

| | | | | | High-temperature |
|---|---|---|---|---|---|
| | | | | | discharge capacity |
| | Charge | Discharge | Irreversible | | retention rate after 150 |
| | capacity | capacity | capacity | Efficiency | cycles |
| | [mAh/g] | [mAh/g] | [mAh/g] | [%] | [%] |
| Working | 558 | 470 | 88 | 84.2 | 72.0 |
| Example 1 | | | | | |
| Working | 570 | 481 | 89 | 84.3 | 77.2 |
| Example 2 | | | | | |
| Working | 566 | 472 | 94 | 83.3 | 80.0 |
| Example 3 | | | | | |
| Working | 572 | 475 | 97 | 83.0 | 82.0 |
| Example 4 | | | | | |
| Working | 575 | 475 | 100 | 82.6 | 82.5 |
| Example 5 | | | | | |
| Comparative | 534 | 458 | 76 | 85.7 | 30.1 |
| Example 1 | | | | | |
| Comparative | — | — | — | — | — |
| Example 2 | | | | | |
| Comparative | — | — | — | — | — |
| Example 3 | | | | | |

In a comparison of the basic physical properties of the carbonaceous materials obtained in Working Examples 1 to 5 of the present invention and the basic physical properties of the carbonaceous material obtained in Comparative Example 1, it can be seen from the fact that the interlayer spacing of d (002) planes increases and the ρ_{Bt} decreases due to oxidation that oxidation disarranges the order of crystals and increases pores (Table 4).

In addition, in a comparison of the electrical characteristics of the carbonaceous materials obtained in Working Examples 1 to 5 of the present invention and the electrical characteristics of the carbonaceous material obtained in Comparative Example 1, it can be seen that the discharge capacity retention rate after 150 cycles at a high temperature becomes high due to oxidation, and it can be seen that the high-temperature cycle characteristics of the carbonaceous materials obtained from plant-derived organic materials are improved by oxidation (Table 5 and FIG. 1).

However, in Comparative Example 2, the oxidation temperature is low at 190° C., so the interlayer spacing of d (002) planes is small, and ρ_{Bt} is also large. Therefore, the effect of oxidation is also small. On the other hand, in Comparative Example 3, the oxidation t temperature is high at 410° C., so the decomposition reaction due to oxidation is accelerated, and the specific surface area becomes large. An increase in the specific surface area leads to an increase in the electrochemical reaction sites, so there is a risk that the amount of the solid electrolyte membrane formed by the decomposition reaction of the electrolyte at the time of charging will increase and that the irreversible capacity will increase due to the resulting lithium consumption. Therefore, an oxidation temperature higher than this temperature is not preferable.

### Working Example 6

First, 300 g of 1% hydrochloric acid was added to 100 g of an extracted coffee residue of roasted coffee beans having the grain diameter of 1 mm, and de-mineral was performed by repeating a washing operation of stirring for 1 hour at 20° C., filtering, and then washing with 300 g of water at 20° C. 3 times so as to obtain a de-mineral coffee extract residue.

Next, 50 g of the resulting de-mineral coffee extract residue was initially introduced into a vertical furnace with a diameter of 50 mm equipped with a raw material supply feeder/stirring device and a perforated plate. The temperature was increased to 220° C. at a heating rate of 100° C./h while introducing air at 5 L/min from the bottom of the perforated plate, and the sample was dried and oxidized at 220° C. The reaction was performed for 1 hour after the temperature reached 220° C. A de-mineral coffee extract residue was newly introduced from the feeder by a temperature control device when the preset temperature was exceeded, and when the internal temperature decreased to the preset temperature, the supply of the de-mineral coffee residue was stopped and the internal temperature was adjusted to the preset temperature.

Next, the de-mineral coffee residue that was subjected to oxidation was subjected to preliminary carbonization by means of detarring for 1 hour at 700° C. under a nitrogen air flow in a tube furnace. This was pulverized using a rod mill to form carbon precursor microparticles. Next, this carbon precursor was subjected to final heat treatment for 1 hour at 1250° C. to obtain a carbonaceous material 6 with an average particle size of 10 μm.

### Working Example 7

Carbonaceous material 7 was obtained in the same manner as in Working Example 6 with the exception that drying and oxidation were performed at 260° C.

### Working Example 8

Carbonaceous material 8 was obtained in the same manner as in Working Example 6 with the exception that drying and oxidation were performed at 300° C.

### Working Example 9

Carbonaceous material 9 was obtained in the same manner as in Working Example 6 with the exception that drying and oxidation were performed at 260° C. in a horizontal furnace with a feeder.

### Working Example 10

Carbonaceous material 10 was obtained in the same manner as in Working Example 6 with the exception that drying and oxidation were performed separately in this order using a vertical furnace. When adjusting the oxidation temperature to the preset temperature, the temperature was adjusted by introducing water into the vertical furnace.

In the working examples, no problems related to temperature management arose during the oxidation step. In addition, in Working Example 10 created with the same method as in Working Examples 1 to 5, it was necessary to introduce 131 g of water in order to adjust the preset temperature in the oxidation step. The oxidation conditions and the contents and characteristics of the ions contained in the resulting carbonaceous materials are respectively shown in Table 6.

TABLE 6

| | Oxidation | | Ca | | | | | |
|---|---|---|---|---|---|---|---|---|
| | temperature | K content | content | Dv₅₀ | SSA | | d₀₀₂ | ρ_{Bt} |
| | [° C.] | [%] | [%] | [μm] | [m²/g] | H/C | [nm] | [g/cm³] |
| Working | 220 | N.D. | N.D. | 10.1 | 9.0 | 0.01 | 0.380 | 1.51 |
| Example 6 | | | | | | | | |
| Working | 260 | N.D. | N.D. | 9.9 | 9.7 | 0.01 | 0.382 | 1.50 |
| Example 7 | | | | | | | | |
| Working | 300 | N.D. | N.D. | 10.2 | 9.8 | 0.01 | 0.385 | 1.48 |
| Example 8 | | | | | | | | |
| Working | 260 | N.D. | N.D. | 10.0 | 9.5 | 0.01 | 0.382 | 1.50 |
| Example 9 | | | | | | | | |
| Working | 260 | N.D. | N.D. | 9.7 | 9.6 | 0.01 | 0.382 | 1.49 |
| Example | | | | | | | | |
| 10 | | | | | | | | |

### (Active Material Doping-Dedoping Tests)

Anodes and nonaqueous electrolyte secondary batteries were produced by performing the aforementioned operations (a) to (c) of the “(Active material doping-dedoping tests)” using the carbonaceous materials 6 to 10 obtained in Working Examples 6 to 10, and the electrode performances thereof were evaluated.

### (High-Temperature Cycle Test)

### (a) Measurement Cell Production Method

First, NMP was added to 94 parts by mass of the carbonaceous material described above and 6 parts by mass of polyvinylidene fluoride (“KF#9100” made by the Kureha Corporation). This was formed into a pasty consistency and applied uniformly to copper foil. After the sample was dried, the coated electrode was stamped into a disc shape with a diameter of 15 mm, and this was pressed so as to form an anode.

Next, NMP was added to 94 parts by mass of lithium cobaltate (LiCoO₂), 3 parts by mass of carbon black, and 3 parts by mass of polyvinylidene fluoride (KF#1300 made by the Kureha Corporation). This was formed into a pasty consistency and then applied uniformly to aluminum foil. After the sample was dried, the coated electrode was stamped into a disc shape with a diameter of 14 mm. Here, the amount of lithium cobaltate in the cathode was adjusted so as to achieve 95% of the charge capacity of the anode active material measured in (c). At this time, the volume of lithium cobaltate was calculated as 150 mAh/g.

Using a pair of electrodes prepared in this way, the same material as that used in the active material doping-dedoping tests was used as an electrolyte solution. A polyethylene gasket was used as a fine porous membrane separator made of borosilicate glass fibers with a diameter of 19 mm to assemble a 2032 coin-type nonaqueous electrolyte lithium secondary battery in an Ar glove box.

### (b) Cycle Test

Charging is performed with a constant current/constant voltage. Charging is performed under charging conditions with a constant current (2 C) until a voltage of 4.2 V is reached. The current is then attenuated (while maintaining a constant voltage) so as to maintain the voltage at 4.2 V, and charging is continued until the current reaches ( 1/100) C. After the completion of charging, the battery circuit was opened for 30 minutes, and discharging was performed thereafter. Discharging was performed at a constant current (2 C) until the battery voltage reached 2.75 V. The first three cycles were performed at 25° C., and subsequent cycles were performed in a constant-temperature bath at 50° C.

The battery characteristics of the lithium secondary batteries produced with the production method described above are shown in Table 7.

TABLE 7

| | | | | High-temperature |
|---|---|---|---|---|
| | | | | discharge |
| | Oxidation | Discharge | Irreversible | capacity retention |
| | temperature | capacity | capacity | rate after |
| | [° C.] | [mAh/g] | [mAh/g] | 150 cycles [%] |
| Working | 220 | 470 | 86 | — |
| Example 6 | | | | |
| Working | 260 | 481 | 88 | 77 |
| Example 7 | | | | |
| Working | 300 | 483 | 90 | — |
| Example 8 | | | | |
| Working | 260 | 480 | 87 | — |
| Example 9 | | | | |
| Working | 260 | 481 | 88 | 78 |
| Example 10 | | | | |

When drying and oxidation were performed in an oxidizing gas atmosphere while mixing and adding the coffee extract residue or the de-mineral product thereof (Working Examples 6 to 9), no abnormal increases in temperature were observed during oxidation. In addition, when anodes were produced using the prepared carbonaceous materials, it was confirmed that secondary batteries with characteristics comparable to those of a battery using a carbonaceous material prepared with a method of introducing water for cooling to adjust the temperature in the oxidation step (Working Example 10) as an anode can be produced. Carbonaceous materials were prepared repeatedly with the same operations several times, and the characteristics thereof were evaluated, but all of the materials yielded the same characteristics, and it was confirmed that there was little fluctuation in the characteristics.

### Reference Example 6

First, 300 g of 1% hydrochloric acid was added to 100 g of an extracted coffee residue, and de-mineral was performed by repeating a washing operation of stirring for 1 hour at 20° C., filtering, and then washing with 300 g of water at 20° C. 3 times so as to obtain a de-mineral coffee extract residue. After the resulting decalcified coffee extract residue was dried at 150° C. in a nitrogen gas atmosphere, preliminary carbonization was performed by means of detarring for 1 hour at 700° C. in a tube furnace under a nitrogen air flow. After this was pulverized using a rod mill, the sample was screened with a 38 μm sieve, and the coarse particles were cut so as to obtain carbon precursor microparticles. Next, this carbon precursor was placed in a horizontal tube furnace and then held and carbonized for 1 hour 1250° C. while flow nitrogen gas so as to obtain carbonaceous material 6 with an average particle size of 6.1 μm.

### Reference Example 7

Reference carbonaceous material 7 was obtained in the same manner as reference carbonaceous material 6 with the exception that a residue obtained by extracting Brazilian beans (arabica variety) with a different degree of roasting was used as a coffee residue.

### Reference Example 8

Reference carbonaceous material 8 was obtained in the same manner as reference carbonaceous material 6 with the exception that a residue obtained by extracting Vietnamese beans (canephora variety) was used as a coffee residue.

### Reference Example 9

First, 171 g of 35% hydrochloric acid (special grade made by Junsei Chemical Co., Ltd.) and 5830 g of purified water were added to 2000 g of an extracted coffee residue (water content: 65%), and the pH was adjusted to 0.5. After the sample was stirred for 1 hour at a liquid temperature of 20° C., the sample was filtered to obtain an acid-treated coffee extract residue. Next, de-mineral was performed by repeating a water washing operation of adding 6000 g of purified water to the acid-treated coffee extract residue and stirring for 1 hour 3 times, and a de-mineral coffee extract residue was thus obtained.

After the resulting de-mineral coffee extract residue was dried at 150° C. in a nitrogen gas atmosphere, the sample was detarred for 1 hour at 380° C. in a tube furnace to obtain a detarred and de-mineral coffee extract residue. Next, 50 g of the resulting detarred and de-mineral coffee extract residue were placed in an alumina case, and oxidation was performed for 1 hour at 260° C. under an air flow in an electric furnace to obtain an oxidized coffee extract residue.

Next, 30 g of the oxidized coffee extract residue were subjected to preliminary carbonization by means of detarring for 1 hour at 700° C. under a nitrogen air flow in a tube furnace. This was pulverized with a rod mill to form carbonaceous precursor microparticles. Next, the carbon precursor microparticles were placed in a horizontal tube furnace and then held and carbonized for 1 hour 1250° C. while flow nitrogen gas so as to obtain reference carbonaceous material 9 with an average particle size of 6.2 μm.

### Reference Example 10

Reference carbonaceous material 10 was obtained in the same manner as in Reference Example 6 with the exception that the average particle size was set to 11 μm.

### Reference Example 11

Reference carbonaceous material 11 was obtained in the same manner as in Reference Example 6 with the exception that the final heat treatment temperature was set to 800° C.

Anodes using the carbonaceous materials of Reference Examples 6 to 11 were produced, and the resistance values measured with the method described below and the battery characteristics measured in the same manner as described above are shown in Table 8.

### (Measurement Cell Production Method)

First, NMP was added to 94 parts by mass of each of the carbonaceous materials obtained in Reference Examples 6 to 11 described above and 6 parts by mass of polyvinylidene fluoride (KF#9100 made by the Kureha Corporation). This was formed into a pasty consistency and applied uniformly to copper foil. After the sample was dried, the coated electrode was stamped into a disc shape with a diameter of 15 mm, and this was pressed so as to form an anode.

Next, NMP was added to 94 parts by mass of lithium cobaltate (LiCoO₂, “Cellseed C-5H made by Nippon Chemical Industrial Co., Ltd.), 3 parts by mass of carbon black, and 3 parts by mass of polyvinylidene fluoride (KF#1300 made by the Kureha Corporation). This was formed into a pasty consistency and then applied uniformly to aluminum foil. After the sample was dried, the coated electrode was stamped into a disc shape with a diameter of 14 mm. Here, the amount of lithium cobaltate in the cathode was adjusted so as to achieve 95% of the charge capacity of the anode active material measured in (c). The volume of lithium cobaltate was calculated as 150 mAh/g.

Using a pair of electrodes prepared in this way, LiPF₆ was added at a proportion of 1.5 mol/L to a mixed solvent prepared by mixing ethylene carbonate, dimethyl carbonate, and methyl ethyl carbonate at a volume ratio of 1:2:2 as an electrolyte solution. A polyethylene gasket was used as a fine porous membrane separator made of borosilicate glass fibers with a diameter of 19 mm to assemble a 2032 coin-type nonaqueous electrolyte lithium secondary battery in an Ar glove box.

### (DC Current Resistance Measurement Method)

First, aging is performed by repeating the charge-discharge cycle twice. The conversion of the current value to a C-rate in aging is performed by calculating the value from the electrical capacitance and mass of lithium cobaltate prescribed above. Charging is performed with a constant current/constant voltage. Charging is performed under charging conditions with a constant current of 0.2 C (the current required to charge for 1 hour is defined as 1 C) until the voltage reaches 4.2 V. The current is then attenuated (while maintaining a constant voltage) so as to maintain the voltage at 4.2 V, and charging is continued until the current reaches ( 1/100) C. After the completion of charging, the battery circuit was opened for 30 minutes, and discharging was performed thereafter. Discharging was performed at a constant current of 0.2 C until the battery voltage reached 2.75 V. The current was respectively set to 0.4 C in the second charge-discharge cycle.

Next, after charging was performed at 0.4 C until the capacity reached 50% of the SOC (State of Charge), pulse charging-discharging was performed in a low-temperature incubator (0° C. atmosphere). The pulse charge-discharge cycle is performed using an open circuit for 600 seconds after 10 seconds of charging at a constant current and then 600 seconds of an open circuit after 10 seconds of discharging are referred to as one set, and measurements are taken at each current of 0.5 C, 1 C, and 2 C. The change in voltage with respect to each current was plotted, and the slope of linear approximation was calculated as the DC resistance.

TABLE 8

| | Dv₅₀ | SSA | d₀₀₂ | | ρ_{Bt} | K | Ca |
|---|---|---|---|---|---|---|---|
| | [μm] | [m²/g] | [nm] | H/C | [g/cm³] | [ppm] | [ppm] |
| Reference | 6.1 | 9.4 | 0.377 | 0.02 | 1.59 | N.D. | N.D. |
| Example 6 | | | | | | | |
| Reference | 5.9 | 9.6 | 0.379 | 0.02 | 1.60 | N.D. | N.D. |
| Example 7 | | | | | | | |
| Reference | 5.4 | 9.8 | 0.379 | 0.02 | 1.54 | N.D. | N.D. |
| Example 8 | | | | | | | |
| Reference | 6.2 | 10.6 | 0.382 | 0.02 | 1.52 | N.D. | N.D. |
| Example 9 | | | | | | | |
| Reference | 11.3 | 5.0 | 0.377 | 0.02 | 1.59 | N.D. | N.D. |
| Example 10 | | | | | | | |
| Reference | 7.2 | 108.0 | 0.402 | 0.12 | 1.51 | N.D. | N.D. |
| Example 11 | | | | | | | |

TABLE 9

| | | | | | | DC resistance | |
|---|---|---|---|---|---|---|---|
| | | Charge | Discharge | Irreversible | | (0° C., | |
| | Dv₅₀ | capacity | capacity | capacity | Efficiency | relative value) | |
| | [μm] | [mAh/g] | [mAh/g] | [mAh/g] | [%] | Input | Output |
| Reference | 6.1 | 500 | 429 | 71 | 85.9 | 87.4 | 88.6 |
| Example 6 | | | | | | | |
| Reference | 5.9 | 496 | 425 | 71 | 85.7 | 87.2 | 88.4 |
| Example 7 | | | | | | | |
| Reference | 5.4 | 513 | 438 | 75 | 85.4 | 87.0 | 88.2 |
| Example 8 | | | | | | | |
| Reference | 6.2 | 551 | 462 | 89 | 83.8 | 87.8 | 88.7 |
| Example 9 | | | | | | | |
| Reference | 11.3 | 534 | 458 | 76 | 85.7 | 100 | 100 |
| Example 10 | | | | | | | |
| Reference | 7.2 | 945 | 510 | 435 | 54.0 | 103 | 105 |
| Example 11 | | | | | | | |

As is clear from Table 9, the resistance is small in an anode using the carbonaceous materials of Reference Examples 6 to 9 having small particle sizes, and the irreversible capacity of batteries using the anode is also small. It can be seen from the above results that the carbonaceous material of the present invention having high purity and specific physical properties is particularly useful for a secondary battery of a hybrid electric vehicle (HEV), which simultaneously requires high input and output characteristics for repeatedly supplying and receiving a large current.

### (Carbonaceous Material Preparation)

In these reference examples, coffee bean residues and coconut shells are prepared as carbonaceous material powders for anodes with the following methods. A carbonaceous material powder using a plant-derived organic material as a raw material is prepared with the following method.

### Reference Example 12

First, 300 g of 1% hydrochloric acid was added to 100 g of an extracted and blended coffee residue, and this was stirred for 1 hour at 20° C. and then filtered. Next, de-mineral was performed by repeating a water washing operation of adding 300 g of water at 20° C., stirring for 1 hour, and filtering 3 times, and a de-mineral coffee extract residue was thus obtained. After the resulting decalcified coffee extract residue was dried in a nitrogen gas atmosphere, preliminary carbonization was performed by means of detarring for 1 hour at 700° C. under a nitrogen air flow. This was pulverized using a rod mill to form carbon precursor microparticles. Next, this carbon precursor was subjected to final heat treatment for 1 hour at 1250° to obtain a reference carbonaceous material 12 with an average particle size of 10 μm. The characteristics of the investigated carbonaceous materials are each shown in Table 10.

### Reference Example 13

Reference carbonaceous material 13 was obtained in the same manner as in Reference Example 12 with the exception that a residue obtained by extracting lightly roasted Brazilian beans was used as a coffee residue. The characteristics of the resulting carbonaceous material are shown in Table 10.

### Reference Example 14

Reference carbonaceous material 14 was obtained in the same manner as in Reference Example 12 with the exception that a residue obtained by extracting deeply roasted Brazilian beans was used as a coffee residue. The characteristics of the resulting carbonaceous material are shown in Table 10.

### Reference Example 15

Reference carbonaceous material 15 was obtained in the same manner as in Reference Example 12 with the exception that the final heat treatment temperature was set to 800° C. The characteristics of the resulting carbonaceous material are respectively shown in Table 10.

### Reference Example 16

After a coconut shell char was pre-heat treated for 1 hour at 600° C. in a nitrogen gas atmosphere (normal pressure), the sample was pulverized to form a powdered carbon precursor with an average particle size of 19 μm. Next, de-mineral was performed by repeating a washing operation of immersing the powdered carbon precursor in 35% hydrochloric acid for 1 hour and then washing the precursor for 1 hour with boiled water 2 times, and a de-mineral powdered carbon precursor was thus obtained. 10 g of the resulting decalcified powdered carbon precursor was placed in a horizontal tube furnace and subjected to final heat treatment for 1 hour at 1200° C. in a nitrogen atmosphere to obtain a reference carbonaceous material 16. The characteristics of the resulting reference carbonaceous material 16 are shown in Table 10.

TABLE 10

| | Carbonaceous | K | Ca | Dv₅₀ | |
|---|---|---|---|---|---|
| | material | [ppm] | [ppm] | [μm] | d₀₀₂ [nm] |
| Reference | Reference | N.D. | N.D. | 10.2 | 0.378 |
| Example 12 | carbonaceous | | | | |
| | material 12 | | | | |
| Reference | Reference | N.D. | N.D. | 9.7 | 0.379 |
| Example 13 | carbonaceous | | | | |
| | material 13 | | | | |
| Reference | Reference | N.D. | N.D. | 7.8 | 0.379 |
| Example 14 | carbonaceous | | | | |
| | material 14 | | | | |
| Reference | Reference | N.D. | N.D. | 9.5 | 0.402 |
| Example 15 | carbonaceous | | | | |
| | material 15 | | | | |
| Reference | Reference | 30 | 170 | 10.0 | 0.384 |
| Example 16 | carbonaceous | | | | |
| | material 16 | | | | |

| | | ρ_{Bt} | ρ_{H} | | SSA |
|---|---|---|---|---|---|
| | H/C | [g/cm³] | [g/cm³] | ρH/ρBt | [m²/g] |
| Reference | 0.02 | 1.57 | 1.88 | 1.19 | 6.2 |
| Example 12 | | | | | |
| Reference | 0.02 | 1.60 | 1.93 | 1.21 | 5.7 |
| Example 13 | | | | | |
| Reference | 0.02 | 1.54 | 2.01 | 1.31 | 6.7 |
| Example 14 | | | | | |
| Reference | 0.12 | 1.51 | 1.70 | 1.13 | 67 |
| Example 15 | | | | | |
| Reference | 0.02 | 1.46 | 2.13 | 1.46 | 6.0 |
| Example 16 | | | | | |

### (Active Material Doping-Dedoping Tests)

### (a) Electrode Production

A solvent was added to the carbonaceous material described above and a binder, and this was formed into a pasty consistency and applied uniformly to copper foil. After drying, the sample was stamped out of the copper foil in a disc shape with a diameter of 15 mm, and this was pressed to form the electrodes of Reference Examples 17 to 24. The compounding ratios of the carbonaceous materials and binders that were used are respectively shown in Table 11.

TABLE 11

| | | Binder | | |
|---|---|---|---|---|
| | Carbonaceous | | Molecular | |
| | material | Type | weight | Electrode composition |
| Reference | Reference | SBR/CMC | 250,000 to | Active material/SBR/CMC = 96/3/1 |
| Example 17 | carbonaceous | | 300,000 | |
| | material 12 | | | |
| Reference | Reference | PVDF/PVA | 25,000 | Active material/PVDF/PVA205 = |
| Example 18 | carbonaceous | | | 94/6/2 |
| | material 12 | | | |
| Reference | Reference | SBR/CMC | 250,000 to | Active material/SBR/CMC = |
| Example 19 | carbonaceous | | 300,000 | 96/3/1 |
| | material 13 | | | |
| Reference | Reference | SBR/CMC | 250,000 to | Active material/SBR/CMC = |
| Example 20 | carbonaceous | | 300,000 | 96/3/1 |
| | material 14 | | | |
| Reference | Reference | PAA | — | Active material/polyacrylic acid |
| Example 21 | carbonaceous | | | salt = 96/4 |
| | material 12 | | | |
| Reference | Reference | PVDF | 280,000 | Active material/PVUF = 96/4 |
| Example 22 | carbonaceous | | | |
| | material 12 | | | |
| Reference | Reference | SBR/CMC | 250,000 to | Active material/SBR/CMC = |
| Example 23 | carbonaceous | | 300,000 | 96/3/1 |
| Reference | material 16 | PVDF/PVA | 25,000 | Active material/PVDF/PVA205 = |
| Example 24 | | | | 94/6/2 |

In the table, the binders of the abbreviations that are used are as follows.

SBR: styrene-butadiene rubber
CMC: carboxymethylcellulose
PVA: polyvinyl alcohol
PAA: polyacrylic acid salt
PVDF: polyvinylidene fluoride (“KF#9100″ made by the Kureha Corporation)”

Anodes and nonaqueous electrolyte secondary batteries were produced by performing the aforementioned operations (b) and (c) of the “(Active material doping-dedoping tests)”, and the electrode performances thereof were evaluated. The initial characteristics of the batteries are shown in Table 12.

### (d) Battery Exposure Test

Lithium secondary batteries with the configurations described above were left for 1 week in air at 25° C. and 50% RH. The production of test batteries and the measurement of battery capacity were performed in the same manner as in the tests prior to exposure with the exception that exposed electrodes were used as test electrodes.

### (e) Cycle Test

### (Anode Production)

The electrode mixture of example carbon 1 was applied uniformly to one side of copper foil with a thickness of 18 μm, and this was heated and dried for 25 minutes at 120° C. After the sample was dried, the sample was stamped into a disc shape with a diameter of 15 mm, and this was pressed so as to form an anode. The mass of the active material of the disc-shaped anode was adjusted to 10 mg.

### (Cathode Production)

First NMP was added to 94 parts by mass of lithium cobaltate (“Cellseed C-5” made by Nippon Chemical Industrial Co., Ltd.), 3 parts by mass of polyvinylidene fluoride (KF#1300 made by the Kureha Corporation), and 3 parts by mass of carbon black. This was mixed to prepare a cathode mixture. The resulting mixture was applied uniformly to aluminum foil with a thickness of 50 μm. After the sample was dried, the coated electrode was stamped into a disc shape with a diameter of 14 mm, and this was pressed so as to form a cathode. The amount of lithium cobaltate in the anode was adjusted to 95% of the charge capacity per unit mass of the active material in Reference Example 17 measured by the method described above. The volume of lithium cobaltate was calculated as 150 mAh/g.

Using a pair of electrodes prepared in this way, LiPF₆ was added at a proportion of 1.5 mol/L to a mixed solvent prepared by mixing ethylene carbonate, dimethyl carbonate, and methyl ethyl carbonate at a volume ratio of 1:2:2 as an electrolyte solution. A polyethylene gasket was used as a fine porous membrane separator made of borosilicate glass fibers with a diameter of 19 mm to assemble a 2032 coin-type nonaqueous electrolyte lithium secondary battery in an Ar glove box.

Here, cycle tests were begun after the sample was aged by repeating three cycles of charging and discharging. Under the constant-current/constant-voltage conditions used in the cycle tests, charging is performed at a constant current density of 2.5 mA/cm² until the battery voltage reaches 4.2 V, and charging is then continued until the current value reaches 50 μA while constantly changing the current value so as to maintain the voltage at 4.2 V (while maintaining a constant voltage). After the completion of charging, the battery circuit was opened for 10 minutes, and discharging was performed thereafter. Discharging was performed at a constant current density of 2.5 mA/cm² until the battery voltage reached 3.0 V. This charging and discharging were repeated 100 times at 50° C., and the discharge capacity after 100 cycles was determined. In addition, a value determined by dividing the discharge capacity after 100 cycles by the discharge capacity of the first cycle was defined as the retention rate (%).

The characteristics of exposure tests and cycle characteristics are shown in Table 12 for the produced lithium secondary batteries.

TABLE 12

| | | | | Initial characteristics | | |
|---|---|---|---|---|---|---|
| | Initial characteristics | | | after exposure | | |
| | Discharge | Irreversible | | Discharge | Irreversible | |
| | capacity | capacity | Efficiency | capacity | capacity | Efficiency |
| | [mAh/g] | [mAh/g] | [%] | [mAh/g] | [mAh/g] | [%] |
| Reference | 451 | 70 | 86.6 | 426 | 73 | 85.4 |
| Example 17 | | | | | | |
| Reference | 426 | 68 | 86.2 | 440 | 69 | 86.5 |
| Example 18 | | | | | | |
| Reference | 453 | 65 | 87.4 | 450 | 65 | 87.3 |
| Example 19 | | | | | | |
| Reference | 469 | 72 | 86.7 | 468 | 73 | 86.5 |
| Example 20 | | | | | | |
| Reference | 430 | 68 | 86.3 | 435 | 69 | 86.3 |
| Example 21 | | | | | | |
| Reference | 464 | 73 | 86.3 | 433 | 78 | 84.7 |
| Example 22 | | | | | | |
| Reference | 380 | 84 | 81.6 | 339 | 98 | 77.6 |
| Example 23 | | | | | | |
| Reference | 328 | 84 | 79.6 | 344 | 102 | 77.1 |
| Example 24 | | | | | | |

| | Increase in irreversible | |
|---|---|---|
| | capacity before and after | Capacity after 100 cycles |
| | exposure | [mAh/g] |
| | [mAh/g] | (Retention rate) |
| Reference | 3 | 322 (81.3%) |
| Example 17 | | |
| Reference | 1 | 322 (80.4%) |
| Example 18 | | |
| Reference | 0 | — |
| Example 19 | | |
| Reference | 1 | — |
| Example 20 | | |
| Reference | 1 | — |
| Example 21 | | |
| Reference | 5 | 135 (34.1%) |
| Example 22 | | |
| Reference | 14 | — |
| Example 23 | | |
| Reference | 18 | — |
| Example 24 | | |

It was confirmed that when the carbonaceous material of the invention of this application is used, the irreversible capacity of the battery does not increase after exposure tests, even if a water-soluble resin is used as a binder. This may be due to the fact that although the carbonaceous material for an anode according to the invention of this application obtained by performing de-mineral in an acidic solvent with a pH level of 3.0 or lower is a non-graphitizable carbonaceous material, the water absorbency is low, so even if a binder with high hygroscopicity such as a water-soluble resin is used, the material does not have a hygroscopicity level that would pose problems as an electrode. Therefore, the nonaqueous electrolyte secondary battery of the invention of this application demonstrated favorable durability in exposure tests. Further, as a result of being able to use a water-soluble resin, the material also demonstrates excellent durability in cycle tests.

The effects of additives used in the nonaqueous electrolyte secondary battery of the present invention were investigated using the carbonaceous materials produced in Reference Examples 12 to 15 described above.

### (Active Material Doping-Dedoping Tests)

### (a) Electrode Production

Nonaqueous electrolyte secondary batteries were produced as follows using the anode materials produced in each of the reference examples described above, and the characteristics thereof were evaluated. Although the carbonaceous material of the present invention is suitable for forming an anode for a nonaqueous electrolyte secondary battery, in order to precisely evaluate the discharge capacity and the irreversible capacity of the battery active material without being affected by fluctuation in the performance of the counter electrode, a lithium secondary battery was formed using the electrode obtained above together with a counter electrode comprising lithium metal with stable characteristics, and the characteristics thereof were evaluated.

A cathode (carbon electrode) was produced as follows. First, N-methyl-2-pyrrolidone was added to 94 parts by mass of the produced anode material (carbonaceous material) and 6 parts by mass of polyvinylidene fluoride, and this was formed into a pasty consistency and uniformly applied to copper foil. After the sample was dried, a sheet-like electrode was stamped into a disc shape with a diameter of 15 mm, and this was pressed to form an electrode. The mass of the carbonaceous material (anode material) in the electrode was adjusted to 10 mg, and the material was pressed so that the filling rate of the carbonaceous material (density of the carbonaceous material in the electrode/true density determined by the butanol method) was approximately 61%.

The anode (lithium electrode) was prepared inside a glove box in an Ar atmosphere. An electrode was formed by spot-welding a stainless steel mesh disc with a diameter of 16 mm on the outer lid of a 2016 coin-type battery can in advance, stamping a thin sheet of metal lithium with a thickness of 0.8 mm into a disc shape with a diameter of 15 mm, and pressing the thin sheet of metal lithium into the stainless steel mesh disc.

### (b) Production of a Test Battery

Using the cathode and the anode described above, LiPF₆ was added at a proportion of 1.5 mol/L to a mixed LiPF₆ solvent prepared by mixing ethylene carbonate, dimethyl carbonate, and methyl ethyl carbonate at a volume ratio of 1:2:2 as an electrolyte solution, and the additives shown in Table 5 were added at a ratio of 1 or 3 wt. %. A polyethylene gasket was used as a fine porous membrane separator made of borosilicate glass fibers with a diameter of 19 mm to assemble a 2016 coin-type nonaqueous electrolyte lithium secondary battery in a glove box with an Ar atmosphere. In addition, the same materials were used as comparative electrolytes in the reference examples (Table 13) with the exception that additives were not used.

### (c) Measurement of Battery Capacity

Charge-discharge tests were performed on a lithium secondary battery with the configuration described above using a charge-discharge tester (TOSCAT″ made by Toyo System Co., Ltd.) in accordance with a constant current/constant voltage method. Here, “charging” refers to a discharging reaction in the test battery, but in this case, the reaction is one in which lithium is inserted into the carbonaceous material, so it will be described as “charging” hereinafter for the sake of convenience. Conversely, “discharging” refers to a charging reaction in the test battery but is described as “discharging” for the sake of convenience since it is a reaction for eliminating lithium from the carbonaceous material. In the constant current/constant voltage method employed here, charging is performed at a constant current density of 0.5 mA/cm² until the battery voltage reaches 0 V, and charging is then continued until the current value reaches 20 μA while constantly changing the current value so as to maintain the voltage at 0 V (while maintaining a constant voltage). A value determined by dividing the electricity supply at this time by the mass of the carbonaceous material of the electrode is defined as the charge capacity (doping capacity) per unit mass of the carbonaceous material (mAh/g). After the completion of charging, the battery circuit was opened for 30 minutes, and discharging was performed thereafter. Discharging is performed at a constant current density of 0.5 mA/cm² until the battery voltage reaches 1.5 V, and a value determined by dividing the amount of electricity discharged at this time by the mass of the carbonaceous material of the electrode is defined as the discharge capacity (dedoping capacity) per unit mass of the carbonaceous material (mAh/g). The irreversible capacity (non-dedoping capacity) (mAh/g) is calculated as the charge capacity minus the discharge capacity, and the efficiency (%) is calculated as (discharge capacity/charge capacity)×100. The charge-discharge capacity and irreversible capacity were determined by averaging 3 measurements for test batteries produced using the same sample.

### (High-Temperature Cycle Test)

### (a) Measurement Cell Production Method

First, NMP was added to 94 parts by mass of the carbonaceous material described above and 6 parts by mass of polyvinylidene fluoride (“KF#9100” made by the Kureha Corporation). This was formed into a pasty consistency and applied uniformly to copper foil. After the sample was dried, the coated electrode was stamped into a disc shape with a diameter of 15 mm, and this was pressed so as to form an anode.

Next, NMP was added to 94 parts by mass of lithium cobaltate (LiCoO₂, “Cellseed C-5H made by Nippon Chemical Industrial Co., Ltd.), 3 parts by mass of carbon black, and 3 parts by mass of polyvinylidene fluoride (KF#1300 made by the Kureha Corporation). This was formed into a pasty consistency and then applied uniformly to aluminum foil. After the sample was dried, the coated electrode was stamped into a disc shape with a diameter of 14 mm. Here, the amount of lithium cobaltate in the cathode was adjusted so as to achieve 95% of the charge capacity of the anode active material measured in (c). At this time, the volume of lithium cobaltate was calculated as 150 mAh/g.

Using a pair of electrodes prepared in this way, the same material as that used in the active material doping-dedoping tests was used as an electrolyte solution. A polyethylene gasket was used as a fine porous membrane separator made of borosilicate glass fibers with a diameter of 19 mm to assemble a 2032 coin-type nonaqueous electrolyte lithium secondary battery in an Ar glove box.

### (b) Cycle Test

Charging is performed with a constant current/constant voltage. Charging is performed under charging conditions with a constant current (2 C; the current required to charge for 1 hour is defined as 1 C) until a voltage of 4.2 V is reached. The current is then attenuated (while maintaining a constant voltage) so as to maintain the voltage at 4.2 V, and charging is continued until the current reaches ( 1/100) C. After the completion of charging, the battery circuit was opened for 30 minutes, and discharging was performed thereafter. Discharging was performed at a constant current (2 C) until the battery voltage reached 2.75 V. The first three cycles were performed at 25° C., and subsequent cycles were performed in a constant-temperature bath at 50° C.

The evaluation of cycle characteristics was performed defining the initial charging-discharging after being transferred to the constant-temperature bath at 50° C. as the first cycle and using a value determined by dividing the discharge capacity after 150 cycles by the discharge capacity of the first cycle as the discharge capacity retention rate (%).

The additives that were used and the characteristics of lithium secondary batteries produced with the production method described above are shown in Table 13. When Reference Example 31 and Reference Examples 25 to 28 are compared, it can be seen that the high-temperature cycle characteristics improve as a result of using an additive having a LUMO value of from −1.10 to 1.11 eV in accordance with the present invention. This is the same for Reference Examples 29 and 30. In addition, it can be seen from Reference Example 32 that the high-temperature cycle characteristics do not improve when the LUMO value exceeds 1.10 eV. On the other hand, since a carbonaceous material having a d002, H/C, or the like deviating from the prescribed ranges was used for the anode in Reference Example 33, the initial characteristics of the battery are poor.

TABLE 13

| | Carbonaceous | | Additive | |
|---|---|---|---|---|
| | material | | amount | Charge capacity |
| | used | Additive | [wt %] | [mAh/g] |
| Reference | Reference | FEC | 1 | 513 |
| Example 25 | carbonaceous | | | |
| | material 12 | | | |
| Reference | Reference | FEC | 3 | 519 |
| Example 26 | carbonaceous | | | |
| | material 12 | | | |
| Reference | Reference | VC | 3 | 507 |
| Example 27 | carbonaceous | | | |
| | material 12 | | | |
| Reference | Reference | CIEC | 3 | 517 |
| Example 28 | carbonaceous | | | |
| | material 12 | | | |
| Reference | Reference | FEC | 3 | 519 |
| Example 29 | carbonaceous | | | |
| | material 13 | | | |
| Reference | Reference | FEC | 3 | 534 |
| Example 30 | carbonaceous | | | |
| | material 14 | | | |
| Reference | Reference | — | — | 537 |
| Example 31 | carbonaceous | | | |
| | material 12 | | | |
| Reference | Reference | PC | 3 | 534 |
| Example 32 | carbonaceous | | | |
| | material 12 | | | |
| Reference | Reference | — | — | 920 |
| Example 33 | carbonaceous | | | |
| | material 15 | | | |

| | | | | Discharge |
|---|---|---|---|---|
| | | | | capacity |
| | Discharge | Irreversible | | retention rate |
| | capacity | capacity | Efficiency | after 150 cycles |
| | [mAh/g] | [mAh/g] | [%] | [%] |
| Reference | 446 | 67 | 86.9 | 59.0 |
| Example 25 | | | | |
| Reference | 451 | 67 | 87.1 | 76.3 |
| Example 26 | | | | |
| Reference | 435 | 72 | 85.9 | 60.4 |
| Example 27 | | | | |
| Reference | 449 | 68 | 86.8 | 70.2 |
| Example 28 | | | | |
| Reference | 450 | 69 | 86.7 | 75.1 |
| Example 29 | | | | |
| Reference | 460 | 74 | 86.1 | 75.8 |
| Example 30 | | | | |
| Reference | 464 | 73 | 86.3 | 30.1 |
| Example 31 | | | | |
| Reference | 462 | 72 | 86.5 | 30.3 |
| Example 32 | | | | |
| Reference | 521 | 399 | 56.6 | — |
| Example 33 | | | | |

### (Additive Abbreviations and LUMO Values in the Table)

VC: vinylene carbonate (0.0155 eV)
FEC: fluoroethylene carbonate (0.9829 eV)
CIEC: chloroethylene carbonate (0.1056 eV)
PC: propylene carbonate (1.3132 eV)
Electrolytes and LUMO values
EC: ethylene carbonate (1.2417 eV)
DMC: dimethyl carbonate (1.1366 eV)
EMC: ethyl methyl carbonate (1.1301 eV)

Further, this specification discloses:

[1] a manufacturing method for an intermediate for manufacturing a carbonaceous material for a nonaqueous electrolyte secondary battery, the method comprising: an oxidation step including a step of drying a coffee extract residue or a de-mineral product thereof in an oxidizing gas atmosphere while introducing and mixing the coffee extract residue or de-mineral product thereof; and a step of detarring the oxidized product;

[2] the method according to [1], wherein the temperature of the oxidizing gas is controlled to at least 200° C. and at most 400° C.;

[3] the method according to [1] or [2], further comprising a step of de-mineral the coffee extract residue using an acidic solution with a pH level of 3.0 or lower at a temperature of at least 0° C. and at most 100° C.;

[4] the method according to [3], further comprising a step of pulverizing the de-mineral raw material composition (coffee extract residue);

[5] a manufacturing method for a carbonaceous material for an anode of a nonaqueous electrolyte secondary battery, the method comprising: a step of heat treatment the intermediate manufactured by the method described in any one of [1] to [3] at a temperature of at least 1000° C. and at most 1500° C.; and a step of pulverizing the intermediate or the product to be heat-treated (fired product);

[6] a manufacturing method for a carbonaceous material for a nonaqueous electrolyte secondary battery, the method comprising a step of heat treatment the intermediate manufactured by the method described in [4] at a temperature of at least 1000° C. and at most 1500° C.;

[7] an anode of a nonaqueous electrolyte secondary battery containing the carbonaceous material for a nonaqueous electrolyte secondary battery manufactured by the method described in [5] or [6];

[8] a nonaqueous electrolyte secondary battery comprising the anode for a nonaqueous electrolyte secondary battery described in [7]; or

[9] a vehicle in which the nonaqueous electrolyte secondary battery described in [8] is mounted.

1. A carbonaceous material for an anode of a nonaqueous electrolyte secondary battery obtained by carbonizing a plant-derived organic material, an atom ratio of hydrogen atoms and carbon atoms (H/C) according to elemental analysis being at most 0.1, an average particle size Dᵥ₅₀ being at least 2 μm and at most 50 μm, an average interlayer spacing of 002 planes determined by powder X-ray diffraction being at least 0.365 nm and at most 0.400 nm, a potassium element content being at most 0.5 mass %, a calcium element content being at most 0.02 mass %, and a true density determined by a pycnometer method using butanol being at least 1.44 g/cm³ and less than 1.54 g/cm³.

2. The carbonaceous material for an anode of a nonaqueous electrolyte secondary battery according to claim 1, wherein the plant-derived organic material contains a coffee bean-derived organic material.

3. The carbonaceous material for an anode of a nonaqueous electrolyte secondary battery according to claim 1, wherein the average particle size Dᵥ₅₀ is at least 2 μm and at most 8 μm.

4. A manufacturing method for an intermediate for producing a carbonaceous material for an anode of a nonaqueous electrolyte secondary battery, the method comprising: a step of de-mineral a plant-derived organic material with an average particle size of at least 100 μm;
an oxidation step of heating the de-mineral organic material at a temperature of at least 200° C. and at most 400° C. in an oxidizing gas atmosphere; and
a step of detarring the oxidized organic material at a temperature of at least 300° C. and at most 1000° C.

5. The manufacturing method for an intermediate for manufacturing a carbonaceous material for an anode of a nonaqueous electrolyte secondary battery according to claim 4, the method further comprising: a step of de-mineral a coffee bean-derived organic material with an average particle size of at least 100 μm;
an oxidation step of heating the de-mineral coffee bean-derived organic material at a temperature of at least 200° C. and at most 400° C. in an oxidizing gas atmosphere while introducing and mixing the organic material; and
a step of detarring the oxidized coffee bean-derived organic material at a temperature of at least 300° C. and at most 1000° C.

6. A manufacturing method for an intermediate for manufacturing a carbonaceous material for an anode of a nonaqueous electrolyte secondary battery, the method comprising: an oxidation treatment step of heating a coffee bean-derived organic material with an average particle size of at least 100 μm at a temperature of at least 200° C. and at most 400° C. in an oxidizing gas atmosphere while introducing and mixing the organic material;
a step of de-mineral the oxidized coffee bean-derived organic material; and
a step of detarring the de-mineral coffee bean-derived organic material at a temperature of at least 300° C. and at most 1000° C.

7. The manufacturing method for an intermediate for a carbonaceous material for an anode of a nonaqueous electrolyte secondary battery according to claim 4, wherein the de-mineral is performed using an acidic solution with a pH level of 3.0 or lower.

8. The manufacturing method for an intermediate for a carbonaceous material for an anode of a nonaqueous electrolyte secondary battery according to claim 4, wherein the de-mineral step is performed at a temperature of at least 0° C. and at most 80° C.

9. The method according to claim 4, further comprising a step of pulverizing the de-mineral organic material.

10. An intermediate obtained by the method described in claim 4.

11. A manufacturing method for a carbonaceous material for an anode of a nonaqueous electrolyte secondary battery, the method comprising: a step of heat treatment the intermediate produced by the method described in claim 4 at a temperature of at least 1000° C. and at most 1500° C.; and
a step of pulverizing the intermediate or the fired product thereof.

12. A manufacturing method for a carbonaceous material for an anode of a nonaqueous electrolyte secondary battery, the method comprising a step of heat treatment the intermediate produced by the method described in claim 9 at a temperature of at least 1000° C. and at most 1500° C.

13. A carbonaceous material for an anode of a nonaqueous electrolyte secondary battery obtained by the manufacturing method described in claim 11 or 12.

14. An anode for a nonaqueous electrolyte secondary battery containing the carbonaceous material for an anode of a nonaqueous electrolyte secondary battery described in claim 13.

15. The anode for a nonaqueous electrolyte secondary battery according to claim 14 containing a water-soluble polymer.

16. A nonaqueous electrolyte secondary battery comprising the anode for a nonaqueous electrolyte secondary battery described in claim 14.

17. The nonaqueous electrolyte secondary battery according to claim 16 containing an additive having a LUMO value within a range of from at least −1.10 eV to at most 1.11 eV, the LUMO value being calculated using an AM1 (Austin Model 1) calculation method of a semiemperical molecular orbital method.

18. A vehicle in which the nonaqueous electrolyte secondary battery described in claim 16 is mounted.

19. An anode for a nonaqueous electrolyte secondary battery containing the carbonaceous material for an anode of a nonaqueous electrolyte secondary battery described in claim 1.
